(19) United States
(12) Patent Application Publication
(10) Pub. No.: US 2026/0342421 A1
(43) Pub. Date: Oct. 29, 2026

(54) INITIAL ACCESS METHOD AND APPARATUS IN WIRELESS COMMUNICATION SYSTEM

(71) Applicant: LG Electronics Inc., Seoul (KR)

(72) Inventors: Byounggill KIM, Seoul (KR); Bonghoe KIM, Seoul (KR); Jongku LEE, Seoul (KR); Kijun KIM, Seoul (KR); Dongsun LEE, Seoul (KR)

(21) Appl. No.: 19/484,696

(22) PCT Filed: May 16, 2023
(86) PCT No.: PCT/KR2023/006621

§ 371 Date: Nov. 14, 2025

(51) Int. Cl. H04B 7/06; H04B 17/309; H04L 5/00; H04W 56/00

(52) U.S. Cl. CPC H04B 7/06952; H04B 17/309; H04L 5/0048; H04W 56/0015

(57) ABSTRACT

According to various embodiments of the present disclosure, a method performed by a user equipment (UE) in a wireless communication system may comprise receiving first reference signals from a plurality of devices, performing a measurement on the first reference signals to select a first device among the plurality of devices, acquiring a synchronization signal block (SSB) based on a first reference signal received from the first device among the first reference signals, acquiring information on pre-scheduled resources based on the SSB, selecting second devices among the plurality of devices based on the information on the pre-scheduled resources, and transmitting information on the second devices to the first device.

### TECHNICAL FIELD

The present disclosure relates to a wireless communication system. More particularly, the present disclosure relates to a device and method for initial access in a wireless communication system.

### BACKGROUND ART

Wireless access systems are widely deployed to provide various types of communication services, such as voice and data. In general, the wireless access system is a multiple access system capable of supporting communication with multiple users by sharing available system resources (bandwidth, transmission power, etc.). Examples of the multiple access system include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

In particular, as many communication devices require large communication capacity, more enhanced mobile broadband (eMBB) communication technology than the existing radio access technology (RAT) is proposed. Not only massive machine type communications (mMTC) which provide various services anytime and anywhere by connecting a large number of devices and objects, but also a communication system considering service/user equipment (UE) sensitive to reliability and latency are proposed. Various technical configurations for this are proposed.

### DISCLOSURE

### Technical Problem

In order to solve the above-described problems, the present disclosure provides an initial access method and device for determining an approximate location of a UE without the help of a global positioning system (GPS) in a Distributed massive Multiple Input Multiple Output (D-MIMO) system and limiting a range of beams that each AP shall transmit for beam alignment between the UE and the AP.

In order to solve the above-described problems, the present disclosure provides proposes a method of signaling the number of resources to be measured without affecting existing UEs.

### Technical Solution

A method of operating a user equipment (UE) in a wireless communication system according to an embodiment of the present disclosure may comprise receiving first reference signals from a plurality of devices, performing a measurement on the first reference signals to select a first device among the plurality of devices, acquiring a synchronization signal block (SSB) based on a first reference signal received from the first device among the first reference signals, acquiring information on pre-scheduled resources based on the SSB, selecting second devices among the plurality of devices based on the information on the pre-scheduled resources, and transmitting information on the second devices to the first device.

Acquiring the information on the pre-scheduled resources based on the SSB may comprise acquiring a primary synchronization signal (PSS), a secondary synchronization signal (SSS), and a physical broadcast channel (PBCH) from the SSB, obtaining a phase difference value between the PSS and the SSS, obtaining a phase modulation value of the PBCH based on the phase difference value, and acquiring information on a number of the pre-scheduled resources based on the phase modulation value.

Acquiring the information on the pre-scheduled resources based on the SSB may comprise acquiring a primary synchronization signal (PSS), a secondary synchronization signal (SSS), a first physical broadcast channel (PBCH), and a second PBCH from the SSB, obtaining a phase difference value between a demodulation reference signal (DMRS) of the first PBCH and a DMRS of the second PBCH, and acquiring information on a number of the pre-scheduled resources based on the phase difference value.

Selecting the second devices among the plurality of devices based on the information on the pre-scheduled resources may comprise receiving second reference signals from the plurality of devices via the pre-scheduled resources, performing a measurement on the second reference signals, and selecting the second devices among the plurality of devices based on a result of performing the measurement on the second reference signals.

Transmitting the information on the second devices to the first device may comprise transmitting a random access request message to the first device, receiving a random access response message from the first device, and transmitting Msg3 including the information on the second devices to the first device.

A user equipment (UE) operating in a wireless communication system according to an embodiment of the present disclosure may comprise one or more transceivers, one or more processors controlling the one or more transceivers, and a memory including one or more instructions performed by the one or more processors. The one or more instructions may comprise receiving first reference signals from a plurality of devices, performing a measurement on the first reference signals to select a first device among the plurality of devices, acquiring a synchronization signal block (SSB) based on a first reference signal received from the first device among the first reference signals, acquiring information on pre-scheduled resources based on the SSB, selecting second devices among the plurality of devices based on the information on the pre-scheduled resources, and transmitting information on the second devices to the first device.

A method of operating a first device in a wireless communication system according to an embodiment of the present disclosure may comprise transmitting, to a user equipment (UE), a reference signal in a first band, receiving, from the UE, information on second devices in the first band, acquiring location information of the UE based on a location of the first device and locations of the second devices, determining third devices and a beam sweeping range of the third devices based on the location information of the UE, and transmitting, to the third devices, a beam sweeping request message including information on the beam sweeping range.

The reference signal may include a synchronization signal block (SSB) including a primary synchronization signal (PSS), a secondary synchronization signal (SSS), and a physical broadcast channel (PBCH), and the SSS may be phase-modulated.

The reference signal may include a synchronization signal block (SSB) including a primary synchronization signal (PSS), a secondary synchronization signal (SSS), a first physical broadcast channel (PBCH), and a second PBCH. A phase difference between a demodulation reference signal (DMRS) of the first PBCH and a DMRS of the second PBCH may be related to a phase modulation value of the first PBCH or the second PBCH.

Receiving, from the UE, the information on the second devices in the first band may comprise receiving, from the UE, a random access request message in the first band, transmitting, to the UE, a random access response message in the first band, and receiving, from the UE, Msg3 including the information on the second devices in the first band.

Based on the first device being included in the third devices, transmitting, to the third devices, the beam sweeping request message including the information on the beam sweeping range may comprise transmitting the beam sweeping request message including the information on the beam sweeping range to remaining third devices excluding the first device from the third devices, and performing a beam sweeping in a second band based on the determined beam sweeping range.

The first band may include B6G (below 6th generation or below 6G) band, and the second band may include at least one of mmWave band or TeraHertz (THz) band.

Transmitting, to the third devices, the beam sweeping request message including the information on the beam sweeping range may comprise transmitting, to the third devices, the beam sweeping request message via an Xn interface.

A first device operating in a wireless communication system according to an embodiment of the present disclosure may comprise one or more transceivers, one or more processors controlling the one or more transceivers, and a memory including one or more instructions performed by the one or more processors. The one or more instructions may comprise transmitting, to a user equipment (UE), a reference signal in a first band, receiving, from the UE, information on second devices in the first band, acquiring location information of the UE based on a location of the first device and locations of the second devices, determining third devices and a beam sweeping range of the third devices based on the location information of the UE, and transmitting, to the third devices, a beam sweeping request message including information on the beam sweeping range.

In a first node according to an embodiment of the present disclosure comprising one or more memories and one or more processors operably connected to the one or more memories, the one or more processors may operate the first node to receive first reference signals from a plurality of devices, perform a measurement on the first reference signals to select a first device among the plurality of devices, acquire a synchronization signal block (SSB) based on a first reference signal received from the first device among the first reference signals, acquire information on pre-scheduled resources based on the SSB, select second devices among the plurality of devices based on the information on the pre-scheduled resources, and transmit information on the second devices to the first device.

In one or more non-transitory computer readable mediums according to an embodiment of the present disclosure storing one or more instructions, the one or more non-transitory computer readable mediums may operate to receive first reference signals from a plurality of devices, perform a measurement on the first reference signals to select a first device among the plurality of devices, acquire a synchronization signal block (SSB) based on a first reference signal received from the first device among the first reference signals, acquire information on pre-scheduled resources based on the SSB, select second devices among the plurality of devices based on the information on the pre-scheduled resources, and transmit information on the second devices to the first device.

### Advantageous Effects

Embodiments of the present disclosure can reduce initial access delay and system overhead by determining an approximate location of a UE in an initial access stage of mmWave/THz D-MIMO systems to select candidate APs to serve the UE and limiting a beam sweeping range of each candidate AP.

Embodiments of the present disclosure can signal the number of measurement resources in a D-MIMO system without affecting existing UEs by performing phase modulation on a synchronization signal block (SSB) to perform signaling.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates a method of processing a transmitted signal applicable to the present disclosure.

FIG. 4 illustrates another example of a wireless device applicable to the present disclosure.

FIG. 5 illustrates an example of a hand-held device applicable to the present disclosure.

FIG. 6 illustrates physical channels applicable to the present disclosure and a signal transmission method using the same.

FIG. 7 illustrates the structure of a radio frame applicable to the present disclosure.

FIG. 8 illustrates a slot structure applicable to the present disclosure.

FIG. 9 illustrates an example of a communication structure providable in a 6G system applicable to the present disclosure.

FIG. 10 illustrates an example of a structure of a perceptron.

FIG. 11 illustrates an example of a structure of a multilayer perceptron.

FIG. 12 illustrates an example of a deep neural network.

FIG. 13 illustrates an example of a convolutional neural network.

FIG. 14 illustrates an example of a filter operation in a convolutional neural network.

FIG. 15 illustrates an example of a neural network structure in which a recurrent loop exists.

FIG. 16 illustrates an example of an operation structure of a recurrent neural network.

FIG. 17 illustrates an electromagnetic spectrum applicable to the present disclosure.

FIG. 18 illustrates a THz communication method applicable to the present disclosure.

FIG. 19 illustrates a THz wireless communication transceiver applicable to the present disclosure.

FIG. 20 illustrates a method of generating a THz signal applicable to the present disclosure.

FIG. 21 illustrates a wireless communication transceiver applicable to the present disclosure.

FIG. 22 illustrates a structure of a transmitter applicable to the present disclosure.

FIG. 23 illustrates a structure of a modulator applicable to the present disclosure.

FIG. 24 illustrates an example of a D-MIMO system applicable to the present disclosure.

FIG. 25 illustrates an example of a frame structure in a D-MIMO system applicable to the present disclosure.

FIG. 26 illustrates an example of UE-centric AP clustering applicable to the present disclosure.

FIG. 27 illustrates an example of initial access in a D-MIMO system applicable to the present disclosure.

FIG. 28 illustrates an example of an initial access method according to an embodiment of the present disclosure.

FIG. 29 illustrates an example of free-scheduled resources according to an embodiment of the present disclosure.

FIG. 30 is a flowchart illustrating a beam search method according to an embodiment of the present disclosure.

FIG. 31 is a flowchart illustrating a beam search method according to another embodiment of the present disclosure.

FIG. 32 is a flowchart illustrating a beam search method according to another embodiment of the present disclosure.

FIG. 33 illustrates an example of a signaling method according to an embodiment of the present disclosure.

FIG. 34 illustrates an example of a signaling method according to another embodiment of the present disclosure.

FIG. 35 is a flowchart illustrating a beam search method according to an embodiment of the present disclosure.

FIG. 36 is a flowchart illustrating a beam search method according to another embodiment of the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”. “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail. LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations. etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

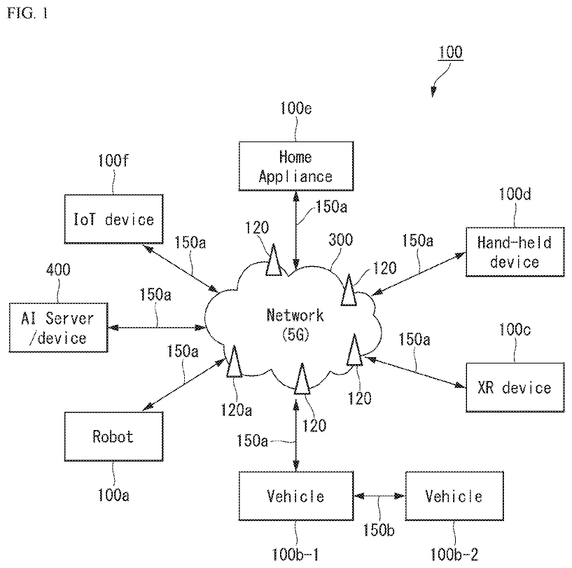

FIG. 1 illustrates an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HLUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

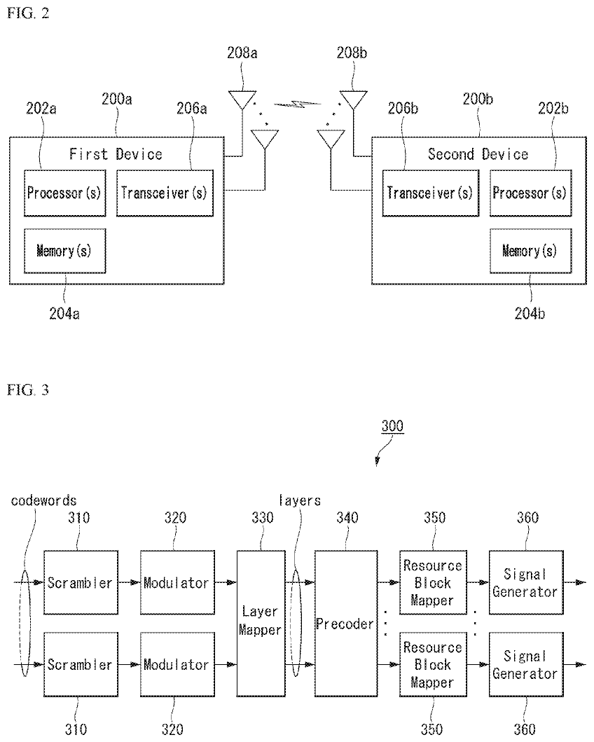

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, (the first wireless device 200a, the second wireless device 200b) may correspond to (the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

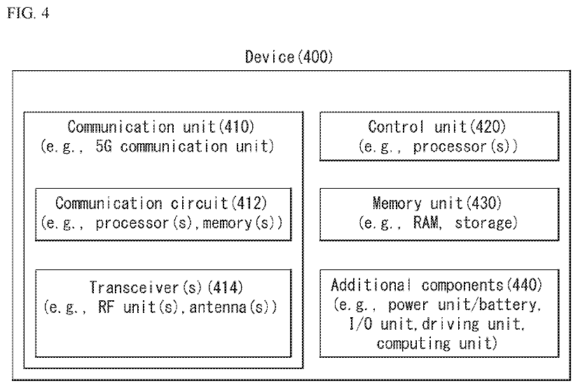

FIG. 3 illustrates a method of processing a transmitted signal applicable to the present disclosure. For example, the transmitted signal may be processed by a signal processing circuit. At this time, a signal processing circuit 1200 may include a scrambler 300, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. In addition, for example blocks 310 to 350 may be implemented in the processors 202a and 202b of FIG. 2 and a block 360 may be implemented in the transceivers 206a and 206b of FIG. 2, without being limited to the above-described embodiments.

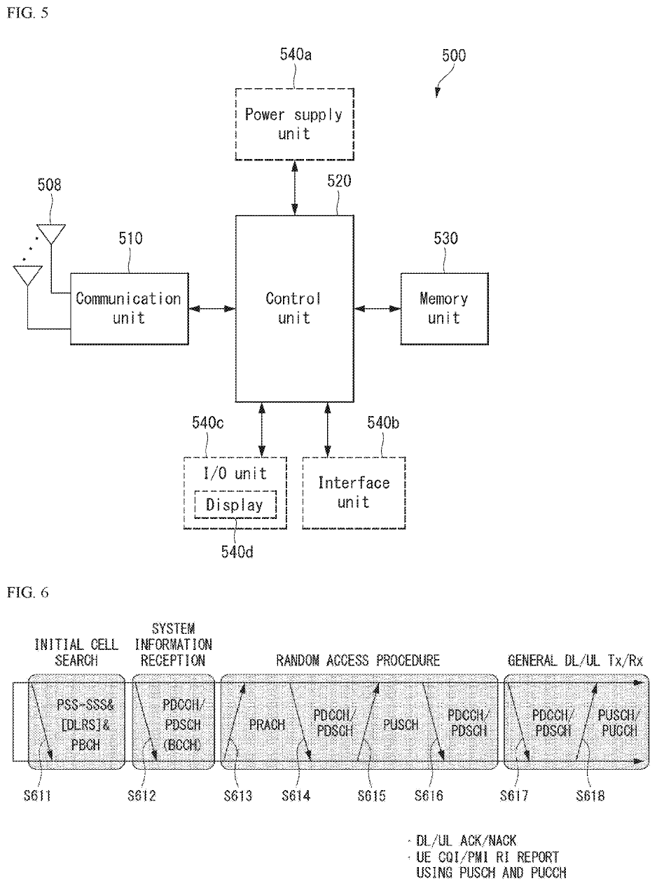

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

FIG. 4 illustrates another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 400 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 320 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 5 illustrates an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 500. In addition, the memory unit 430 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 440c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 5 illustrates physical channels applicable to the present disclosure and a signal transmission method using the same.

The UE which is turned on again in a state of being turned off or has newly entered a cell performs initial cell search operation in step S1011 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. The UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

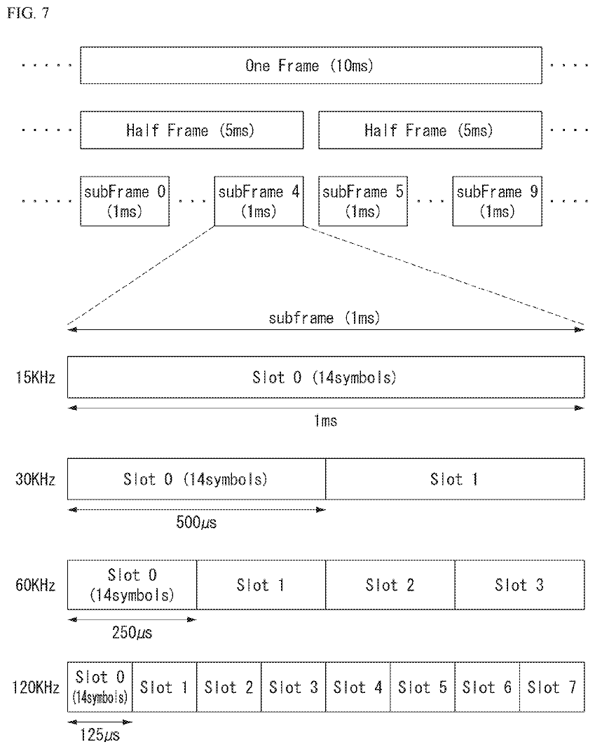

FIG. 7 illustrates the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | ${N}_{symb}^{slot}$ | ${N}_{symb}^{frame , μ}$ | ${N}_{symb}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | ${N}_{symb}^{slot}$ | ${N}_{symb}^{frame , μ}$ | ${N}_{symb}^{subframe , μ}$ |
|---|---|---|---|
| 2 | 12 | 40 | 4 |

In Tables 1 and 2 above. N^{slot}_{symb} may indicate the number of symbols in a slot, N^{frame,μ}ₛₗₒₜ may indicate the number of slots in a frame, and N_{subframe,μ}ₛₗₒₜ may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support multiple numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

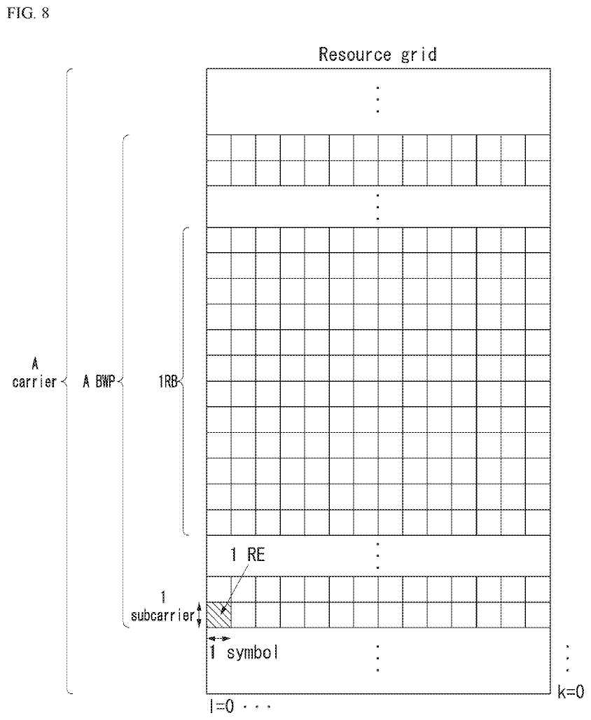

FIG. 8 illustrates a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P)RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

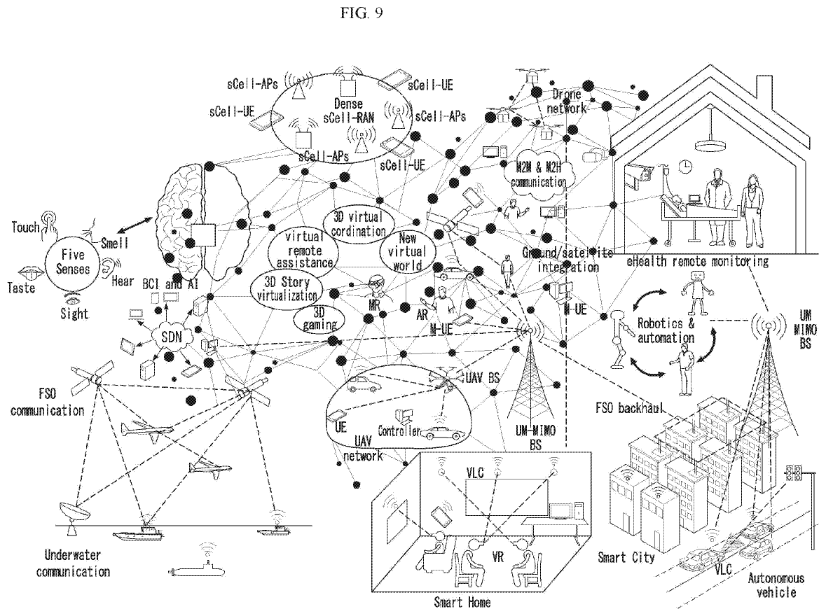

FIG. 9 illustrates an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Core Implementation Technology of 6G System

### Artificial Intelligence (AI)

Technology which is most important in the 6G system and will be newly introduced is AI. AI was not involved in the 4G system. The 5G system will support partial or very limited AI. However, the 6G system will support AI for full automation. Advance in machine learning will create a more intelligent network for real-time communication in 6G. When AI is introduced to communication, real-time data transmission can be simplified and improved. AI may determine a method of performing complicated target tasks using countless analysis. That is, AI can increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, and in particular, deep learning has been focused on the wireless resource management and allocation field. However, such studies have been gradually developed to the MAC layer and the physical layer, and in particular, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. The machine learning may also be used for antenna selection, power control, symbol detection, etc. in the MIMO system.

However, application of a deep neutral network (DNN) for transmission in the physical layer may have the following problems.

A deep learning based AI algorithm requires a lot of training data in order to optimize training parameters. However, due to limitations in acquiring data in a specific channel environment as the training data, a lot of training data is used offline. Static training for the training data in the specific channel environment may cause a contradiction between the diversity and dynamic characteristics of a radio channel.

Currently, the deep learning mainly targets real signals. However, signals of the physical layer of wireless communication are complex signals. For matching of the characteristics of a wireless communication signal, studies on a neural network for detecting a complex domain signal are further required.

Hereinafter, machine learning is described in more detail.

Machine learning refers to a series of operations to train a machine in order to create a machine capable of doing tasks that people cannot do or are difficult for people to do. Machine learning requires data and learning models. In the machine learning, a data learning method may be roughly divided into three methods, that is, supervised learning, unsupervised learning and reinforcement learning.

Neural network learning is to minimize an output error. The neural network learning refers to a process of repeatedly inputting training data to a neural network, calculating an error of an output and a target of the neural network for the training data, backpropagating the error of the neural network from an output layer to an input layer of the neural network for the purpose of reducing the error, and updating a weight of each node of the neural network.

The supervised learning may use training data labeled with a correct answer, and the unsupervised learning may use training data which is not labeled with a correct answer. That is, for example, in supervised learning for data classification, training data may be data in which each training data is labeled with a category. The labeled training data may be input to the neural network, and the error may be calculated by comparing the output (category) of the neural network with the label of the training data. The calculated error is backpropagated in the neural network in the reverse direction (i.e., from the output layer to the input layer), and a connection weight of respective nodes of each layer of the neural network may be updated based on the backpropagation. Change in the updated connection weight of each node may be determined depending on a learning rate. The calculation of the neural network for input data and the backpropagation of the error may construct a learning cycle (epoch). The learning rate may be differently applied based on the number of repetitions of the learning cycle of the neural network. For example, in the early stage of learning of the neural network, efficiency can be increased by allowing the neural network to rapidly ensure a certain level of performance using a high learning rate, and in the late of learning, accuracy can be increased using a low learning rate.

The learning method may vary depending on the feature of data. For example, in order for a reception end to accurately predict data transmitted from a transmission end on a communication system, it is preferable that learning i10s performed using the supervised learning rather than the unsupervised learning or the reinforcement learning.

The learning model corresponds to the human brain and may be regarded as the most basic linear model. However, a paradigm of machine learning using, as the learning model, a neural network structure with high complexity, such as artificial neural networks, is referred to as deep learning.

Neural network cores used as the learning method may roughly include a deep neural network (DNN) method, a convolutional deep neural network (CNN) method, and a recurrent Boltzmann machine (RNN) method.

The artificial neural network is an example of connecting several perceptrons.

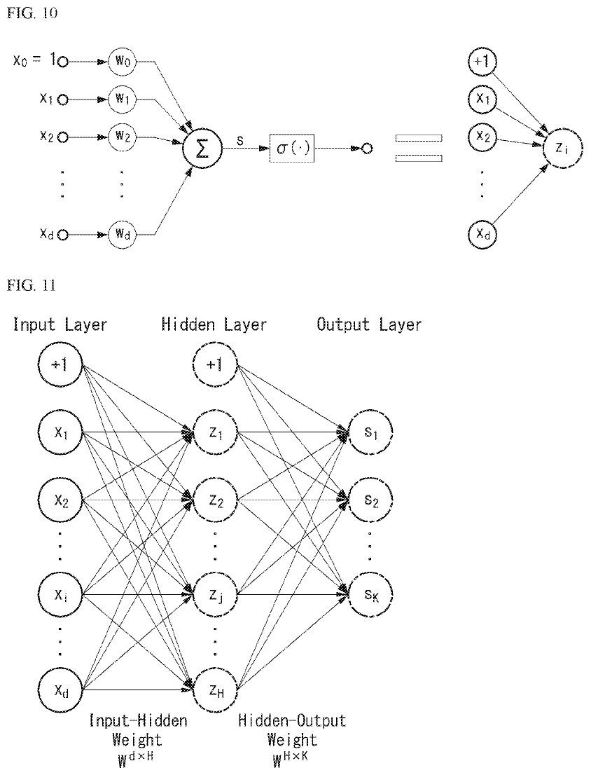

FIG. 10 illustrates an example of a structure of a perceptron.

Referring to FIG. 10, when an input vector x=(x1, x2, . . . , xd) is input, each component is multiplied by a weight (W1, W2, . . . , Wd), and all the results are summed. After that, the entire process of applying an activation function σ(⋅) is called a perceptron. The huge artificial neural network structure may extend the simplified perceptron structure illustrated in FIG. 10 to apply the input vector to different multidimensional perceptrons. For convenience of explanation, an input value or an output value is referred to as a node.

The perceptron structure illustrated in FIG. 10 may be described as consisting of a total of three layers based on the input value and the output value. FIG. 11 illustrates an artificial neural network in which the number of (d+1) dimensional perceptrons between a first layer and a second layer is H, and the number of (H+1) dimensional perceptrons between the second layer and a third layer is K, by way of example. FIG. 11 illustrates an example of a structure of a multilayer perceptron.

A layer where the input vector is located is called an input layer, a layer where a final output value is located is called an output layer, and all layers located between the input layer and the output layer are called a hidden layer. FIG. 11 illustrates three layers, by way of example. However, since the number of layers of the artificial neural network is counted excluding the input layer, it can be seen as a total of two layers. The artificial neural network is constructed by connecting the perceptrons of a basic block in two dimensions.

The above-described input layer, hidden layer, and output layer can be jointly applied in various artificial neural network structures, such as CNN and RNN to be described later, as well as the multilayer perceptron. The greater the number of hidden layers, the deeper the artificial neural network is, and a machine learning paradigm that uses the sufficiently deep artificial neural network as a learning model is called deep learning. In addition, the artificial neural network used for deep learning is called a deep neural network (DNN).

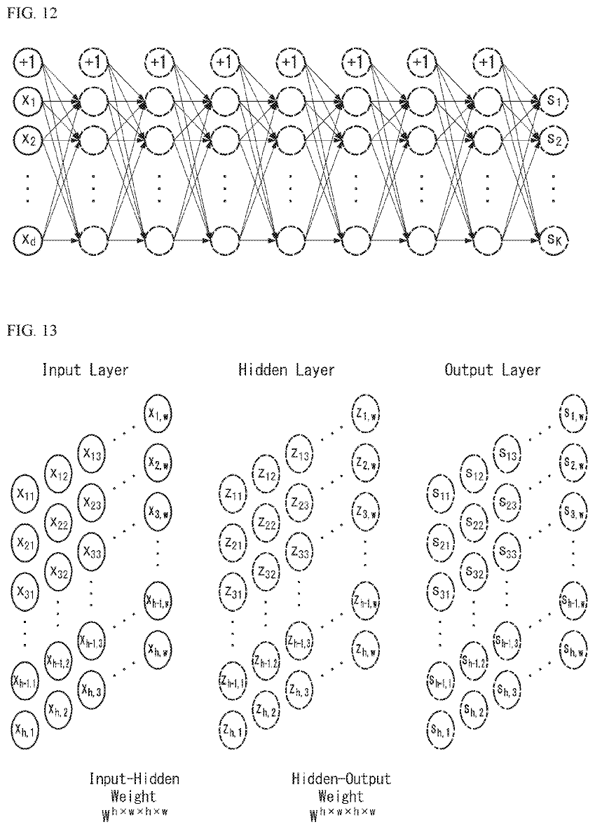

The deep neural network illustrated in FIG. 12 is a multilayer perceptron consisting of eight hidden layers+eight output layers. The multilayer perceptron structure is expressed as a fully connected neural network. In the fully connected neural network, a connection relationship does not exist between nodes located at the same layer, and a connection relationship exists only between nodes located at adjacent layers. The DNN has a fully connected neural network structure and is composed of a combination of multiple hidden layers and activation functions, so it can be usefully applied to understand correlation characteristics between input and output. The correlation characteristic may mean a joint probability of input and output.

Based on how the multiple perceptrons are connected to each other, various artificial neural network structures different from the above-described DNN can be formed.

In the DNN, nodes located inside one layer are arranged in a one-dimensional longitudinal direction. However, in FIG. 13, it may be assumed that w nodes horizontally and h nodes vertically are arranged in two dimensions (convolutional neural network structure of FIG. 13). In this case, since in a connection process leading from one input node to the hidden layer, a weight is given for each connection, a total of h×w weights needs to be considered. Since there are h×w nodes in the input layer, a total of h2w2 weights are required between two adjacent layers.

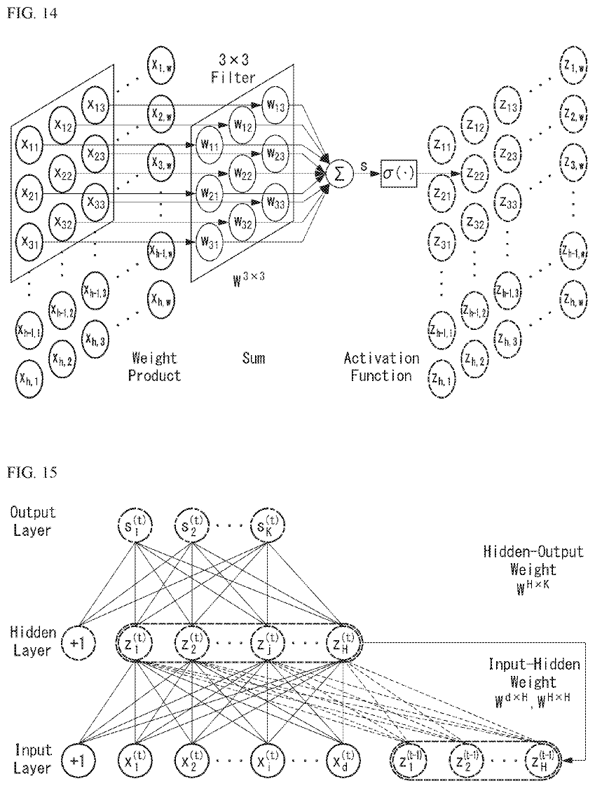

The convolutional neural network of FIG. 13 has a problem in that the number of weights increases exponentially depending on the number of connections. Therefore, instead of considering the connections of all the nodes between adjacent layers, it is assumed that a small-sized filter exists, and a weighted sum and an activation function calculation are performed on an overlap portion of the filters as illustrated in FIG. 14.

One filter has a weight corresponding to the number as much as its size, and learning of the weight may be performed so that a certain feature on an image can be extracted and output as a factor. In FIG. 14, a filter having a size of 3×3 is applied to the upper leftmost 3×3 area of the input layer, and an output value obtained by performing a weighted sum and an activation function calculation for a corresponding node is stored in z22.

The filter performs the weighted sum and the activation function calculation while moving horizontally and vertically by a predetermined interval when scanning the input layer, and places the output value at a location of a current filter. This calculation method is similar to the convolution operation on images in the field of computer vision. Thus, a deep neural network with this structure is referred to as a convolutional neural network (CNN), and a hidden layer generated as a result of the convolution operation is referred to as a convolutional layer. In addition, a neural network in which a plurality of convolutional layers exists is referred to as a deep convolutional neural network (DCNN).

At the node where a current filter is located at the convolutional layer, the number of weights may be reduced by calculating a weighted sum including only nodes located in an area covered by the filter. Hence, one filter can be used to focus on features for a local area. Accordingly, the CNN can be effectively applied to image data processing in which a physical distance on the 2D area is an important criterion. In the CNN, a plurality of filters may be applied immediately before the convolution layer, and a plurality of output results may be generated through a convolution operation of each filter.

There may be data whose sequence characteristics are important depending on data attributes. A structure, in which a method of inputting one element on the data sequence at each time step considering a length variability and a relationship of the sequence data and inputting an output vector (hidden vector) of a hidden layer output at a specific time step together with a next element on the data sequence is applied to the artificial neural network, is referred to as a recurrent neural network structure.

FIG. 15 illustrates an example of a neural network structure in which a recurrent loop exists.

Referring to FIG. 15, a recurrent neural network (RNN) is a structure in which in a process of inputting elements (x1(t), x2(t), . . . , xd(t)) of any line of sight ‘t’ on a data sequence to a fully connected neural network, hidden vectors (z1(t−1), z2(t−1), . . . , zH(t−1)) are input together at an immediately previous time step (t−1) to apply a weighted sum and an activation function. A reason for transferring the hidden vectors at a next time step is that information within the input vector in previous time steps is considered to be accumulated on the hidden vectors of a current time step.

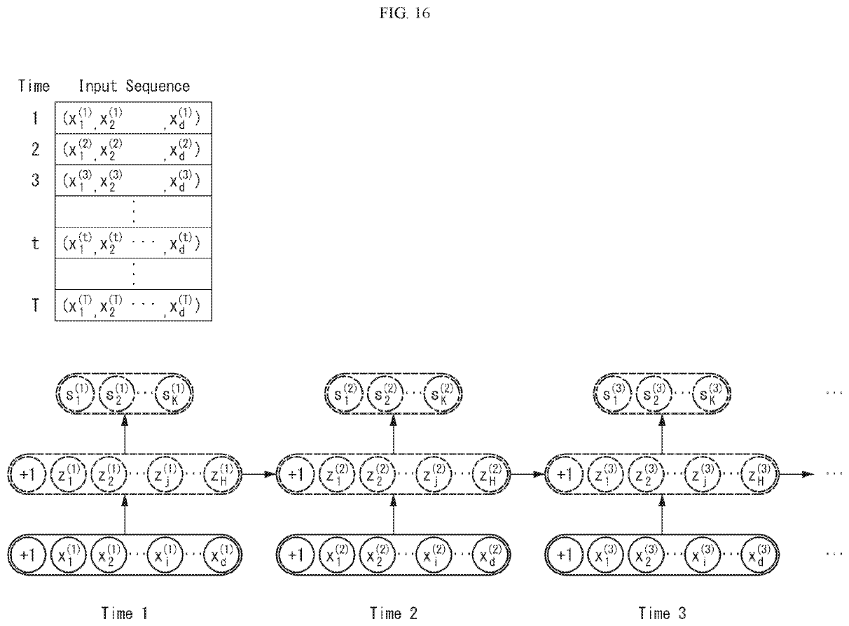

FIG. 16 illustrates an example of an operation structure of a recurrent neural network.

Referring to FIG. 16, the recurrent neural network operates in a predetermined order of time with respect to an input data sequence.

Hidden vectors (z1(1), z2(1), . . . , zH(1)) when input vectors (x1(t), x2(t), . . . , xd(t)) at a time step 1 are input to the recurrent neural network, are input together with input vectors (x1(2), x2(2), . . . , xd(2)) at a time step 2 to determine vectors (z1(2), z2(2), . . . , zH(2)) of a hidden layer through a weighted sum and an activation function. This process is repeatedly performed at time steps 2, 3, . . . , T.

When a plurality of hidden layers are disposed in the recurrent neural network, this is referred to as a deep recurrent neural network (DRNN). The recurrent neural network is designed to be usefully applied to sequence data (e.g., natural language processing).

A neural network core used as a learning method includes various deep learning methods such as a restricted Boltzmann machine (RBM), a deep belief network (DBN), and a deep Q-network, in addition to the DNN, the CNN, and the RNN, and may be applied to fields such as computer vision, speech recognition, natural language processing, and voice/signal processing.

Recently, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver, rather than a traditional communication framework in the fundamental signal processing and communication mechanism. For example, deep learning-based channel coding and decoding, deep learning-based signal estimation and detection, deep learning-based MIMO mechanism, AI-based resource scheduling and allocation, and the like, nay be included.

### Terahertz (THz) Communication

THz communication may be applied to the 6G system. For example, a data transfer rate can be increased by increasing a bandwidth. This can be performed by using sub-TH communication as a wide bandwidth and applying advanced massive MIMO technology.

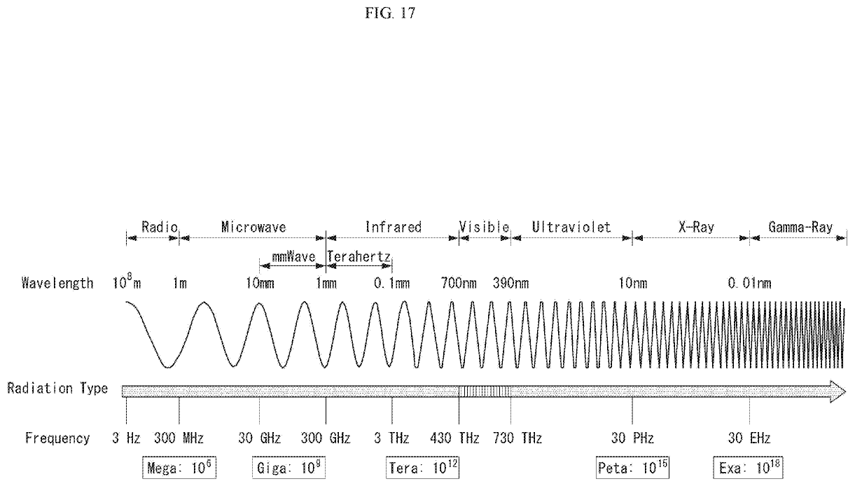

FIG. 17 illustrates an electromagnetic spectrum applicable to the present disclosure. Referring to FIG. 17, for example, THz waves, which are known as sub-millimeter radiation, generally indicate a frequency band between 0.1 THz and 10 THz with the corresponding wavelengths in the range of 0.03 mm-3 mm. A band range of 100 GHz to 300 GHz (sub THz band) is regarded as a main part of the THz band for cellular communication. When the sub-THz band is added to the mmWave band, the 6G cellular communication capacity increases. 300 GHz-3 THz among the defined THz band is in a far infrared (IR) frequency band. Although the 300 GHz-3 THz band is part of the optical band, it is at the border of the optical band and is immediately after the RF band. Therefore, this 300 GHz-3 THz band shows similarity with RF.

The main characteristics of THz communication include (i) a bandwidth widely available to support a very high data transfer rate and (ii) a high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Through this, an advanced adaptive arrangement technology capable of overcoming a range limitation can be used.

### Optical Wireless Technology

Optical wireless communication (OWC) technologies are envisioned for 6G communication in addition to RF based communications for all possible device-to-access networks. These networks access network-to-backhaul/fronthaul network connectivity. The OWC technologies have already been used since 4G communication systems, but will be used more widely to meet the demands of the 6G communication system. The OWC technologies, such as light fidelity, visible light communication, optical camera communication, and free space optical (FSO) communication based on the optical band, are already well-known technologies. Communications based on wireless optical technologies can provide very high data rates, low latencies, and secure communications. LiDAR (light detection and ranging), which is also based on the optical band, is a promising technology for very high-resolution 3D mapping in 6G communications.

### FSO Backhaul Network

Characteristics of a transmitter and a receiver of the FSO system are similar to characteristics of an optical fiber network. Therefore, data transmission of the FSO system similar to that of the optical fiber system. Accordingly, FSO can be a good technology for providing backhaul connectivity in the 6G system along with the optical fiber network. If FSO is used, very long-distance communication is possible even at a distance of 10,000 km or more. FSO supports massive backhaul connectivity for remote and non-remote areas such as sea, space, underwater, and isolated islands. FSO also supports cellular base station connectivity.

### Massive MIMO Technology

One of core technologies for improving spectral efficiency is to apply MIMO technology. When the MIMO technology is improved, the spectral efficiency is also improved. Therefore, massive MIMO technology will be important in the 6G system. Since the MIMO technology uses multiple paths, multiplexing technology and beam generation and management technology suitable for the THz band should be significantly considered so that data signals can be transmitted through one or more paths.

### Block Chain

A block chain will be an important technology for managing large amounts of data in future communication systems. The block chain is a form of distributed ledger technology, and the distributed ledger is a database distributed across numerous nodes or computing devices. Each node duplicates and stores the same copy of the ledger. The block chain is managed by a P2P (peer to peer) network. This may exist without being managed by a centralized institution or server. Block chain data is collected together and is organized into blocks. The blocks are connected to each other and protected using encryption. The block chain completely complements large-scale IoT through improved interoperability, security, privacy, stability, and scalability. Accordingly, the block chain technology provides several functions such as interoperability between devices, high-capacity data traceability, autonomous interaction of different IoT systems, and large-scale connection stability of 6G communication systems.

### 3D Networking

The 6G system integrates the ground and air networks to support communications for users in the vertical extension. The 3D BSs will be provided by low-orbit satellites and UAVs. The addition of new dimensions in terms of height and the associated degrees of freedom makes 3D connectivity significantly different from traditional 2D networks.

### Quantum Communication

Unsupervised reinforcement learning in networks is promising in the context of 6G networks. Supervised learning approaches will not be practical for labeling large amounts of data generated in 6G. Unsupervised learning does not require labeling. Therefore, this technique can be used to create the representations of complex networks autonomously. By combining reinforcement learning and unsupervised learning, it is possible to operate the network truly autonomously.

### Unmanned Aerial Vehicle

An unmanned aerial vehicle (UAV) or drone will be an important factor in 6G wireless communication. In most cases, a high-speed data wireless connection is provided using UAV technology. A base station entity is installed in the UAV to provide cellular connectivity. The UAVs have specific features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC, and mMTC. The UAV can also support a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Cell-Free Communication

The tight integration of multiple frequencies and different communication technologies is very important in 6G systems. As a result, the user can move seamlessly from one network to another network without the need for making any manual configurations in the device. The best network is automatically selected from the available communication technology. This will break the limits of the concept of cells in wireless communications. Currently, the user's movement from one cell to another cell causes too many handovers in dense networks, and also causes handover failures, handover delays, data losses, and the ping-pong effect. The 6G cell-free communications will overcome all these and provide better QoS. Cell-free communication will be achieved through multi-connectivity and multi-tier hybrid techniques and by different and heterogeneous radios in the devices.

### Integration of Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without battery will be supported in 6G communication.

### Integration of Sensing and Communication

An autonomous wireless network is a function for continuously detecting a dynamically changing environment state and exchanging information between different nodes. In 6G, sensing will be tightly integrated with communication to support autonomous systems.

### Integration of Access Backhaul Network

In 6G, the density of access networks will be enormous. Each access network is connected by optical fiber and backhaul connectivity such as FSO network. To cope with a very large number of access networks, there will be a tight integration between the access and backhaul networks.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is anew beamforming method that differs significantly from MIMO systems because this uses a software-defined antenna. HBF will be a very effective approach for efficient and flexible transmission and reception of signals in multi-antenna communication devices in 6G.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Large Intelligent Surface (LIS)

In the THz band signal, since the straightness is strong, there may be many shaded areas due to obstacles. By installing the LIS near these shaded areas, LIS technology, that expands a communication area, enhances communication stability, and enables additional optional services, becomes important. The LIS is an artificial surface made of electromagnetic materials, and can change propagation of incoming and outgoing radio waves. The LIS can be viewed as an extension of massive MIMO, but is different from the massive MIMO in an array structure and an operating mechanism. Further, the LIS has an advantage such as low power consumption, because this operates as a reconfigurable reflector with passive elements, that is, signals are only passively reflected without using active RF chains. In addition, since each of the passive reflectors of the LIS has to independently adjust the phase shift of an incident signal, this may be advantageous for wireless communication channels. By properly adjusting the phase shift through an LIS controller, the reflected signal can be collected at a target receiver to boost the received signal power.

### Terahertz (THz) Wireless Communication

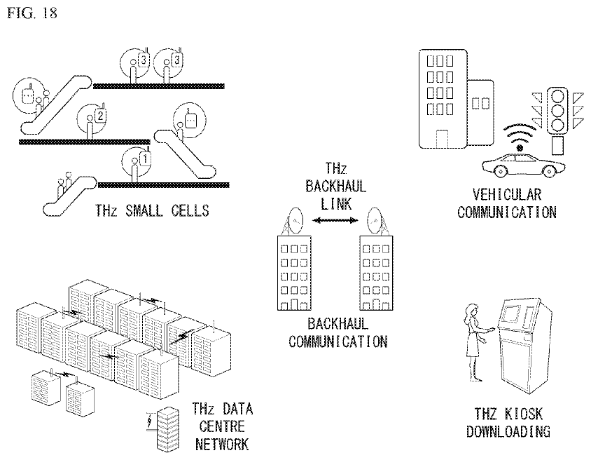

FIG. 18 illustrates a THz communication method applicable to the present disclosure.

Referring to FIG. 18, THz wireless communication uses wireless communication using a THz wave having a frequency of approximately 0.1 to 10 THz (1 THz=1012 Hz) and may refer to THz band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays, has a shorter wavelength than the RF/millimeter wave to have high straightness, and is capable of beam convergence.

In addition, the photon energy of the THz wave is only a few meV and thus is harmless to the human body. A frequency band which is expected to be used for THz wireless communication may be D-band (110 GHz to 170 GHz) or H-band (220 GHz to 325 GHz) band with a low propagation loss due to molecular absorption in air. Standardization discussion on THz wireless communication is being discussed mainly in IEEE 802.15 THz working group (WG) in addition to 3GPP, and standard documents issued by a task group (TG) of IEEE 802.15 (e.g., TG3d, TG3e) can specify and supplement the description of the present disclosure. The THz wireless communication may be applied to wireless cognition, sensing, imaging, wireless communication, THz navigation, etc.

Specifically, referring to FIG. 18, a THz wireless communication scenario may be classified into a macro network, a micro network, and a nanoscale network. In the macro network, THz wireless communication may be applied to vehicle-to-vehicle (V2V) connectivity and backhaul/fronthaul connectivity. In the micro network, THz wireless communication may be applied to near-field communication such as indoor small cells, fixed point-to-point or multi-point connection such as wireless connection in a data center, and kiosk downloading. Table 5 below shows an example of technology which can be used in the THz wave.

TABLE 5

| | |
|---|---|
| Transceivers Device | Available immature: UTC-PD, RTD and SBD |
| Modulation and | Low order modulation techniques (OOK, QPSK), |
| coding | LDPC, Reed Soloman, Hamming, Polar, Turbo |
| Antenna | Omni and Directional, phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

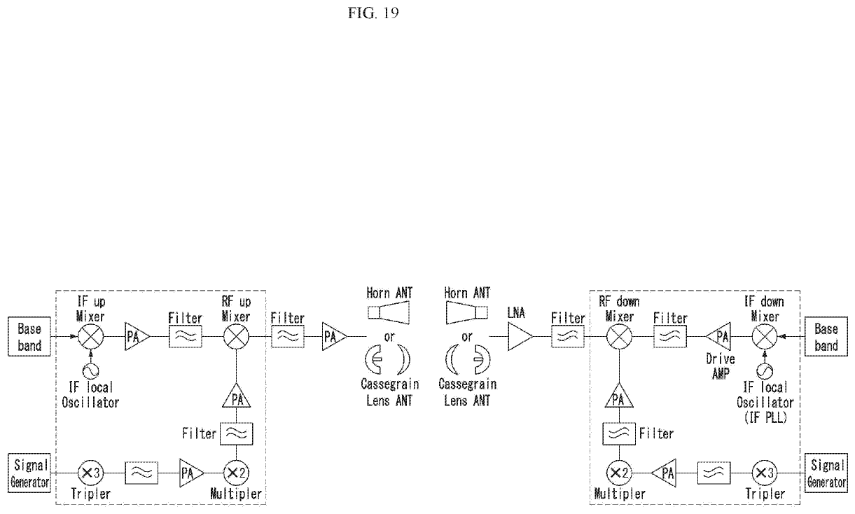

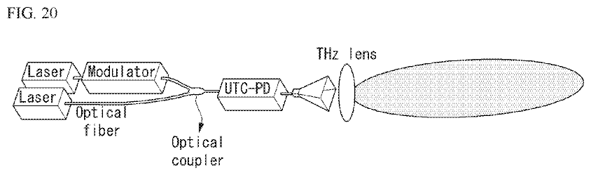

FIG. 19 illustrates a THz wireless communication transceiver applicable to the present disclosure.

Referring to FIG. 19, THz wireless communication can be classified based on a method for generating and receiving THz. The method of generating THz can be classified as an optical device or an electronic device-based technology.

The method of generating THz using an electronic device includes a method using a semiconductor device such as a resonant tunneling diode (RTD), a method using a local oscillator and a multiplier, a monolithic microwave integrated circuit (MMIC) method using a compound semiconductor high electron mobility transistor (HEMT) based integrated circuit, a method using a Si-CMOS based integrated circuit, and the like. In FIG. 19, a multiplier (e.g., doubler, tripler, multiplier) is applied to increase the frequency, and radiation is performed by an antenna via a subharmonic mixer. Since the THz band forms a high frequency, the multiplier is essential. Here, the multiplier is a circuit that allows the frequency to have an output frequency which is N times an input frequency, and the multiplier matches a desired harmonic frequency and filters out all the remaining frequencies. In addition, beamforming may be implemented by applying an array antenna or the like to the antenna of FIG. 19. In FIG. 19, IF denotes an intermediate frequency, a tripler and a multiplier denote a multiplier, PA denotes a power amplifier, LNA denotes a low noise amplifier, and PLL denotes a phase-locked loop.

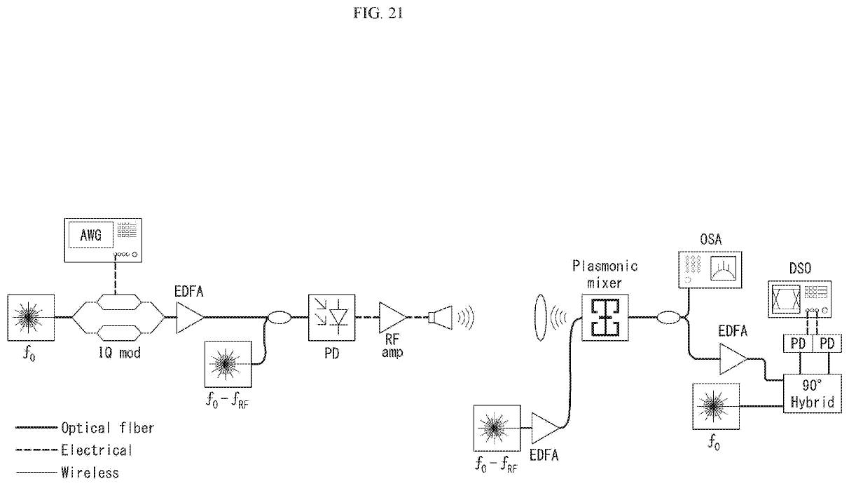

FIG. 20 illustrates a method of generating a THz signal applicable to the present disclosure. FIG. 21 illustrates a wireless communication transceiver applicable to the present disclosure.

Referring to FIGS. 20 and 21, the optical device-based THz wireless communication technology refers to a method of generating and modulating a THz signal using an optical device. The optical device-based THz signal generation technology refers to a technology that generates an ultrahigh-speed optical signal using a laser and an optical modulator and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the optical device-based THz signal, as illustrated in FIG. 20, a laser diode, a broadband optical modulator, and an ultrahigh-speed photodetector are required. In FIG. 20, light signals of two lasers having different wavelengths are combined to generate a THz signal corresponding to difference in a wavelength between the lasers. In FIG. 20, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 21, an erbium-doped fiber amplifier (EDFA) denotes an optical fiber amplifier to which erbium is added, a photo detector (PD) denotes a semiconductor device capable of converting an optical signal into an electrical signal, and OSA denotes an optical sub-assembly in which various optical communication functions (e.g., photoelectric conversion, electrophotic conversion, etc.) are modularized as one component, and DSO denotes a digital storage oscilloscope.

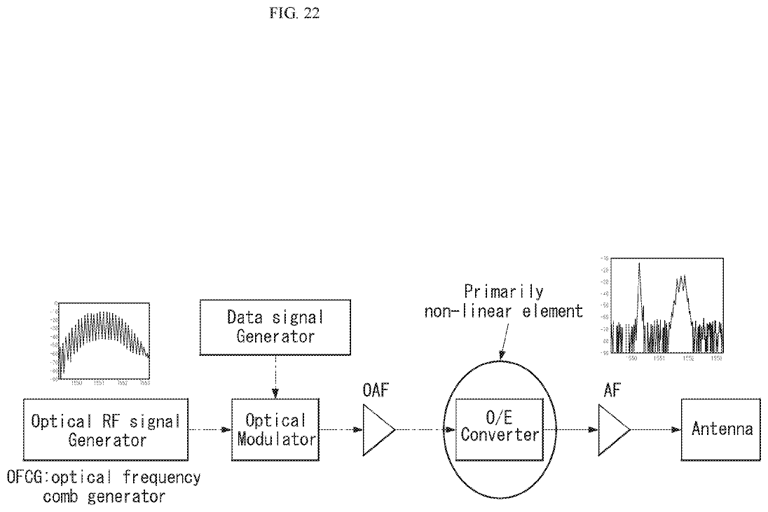

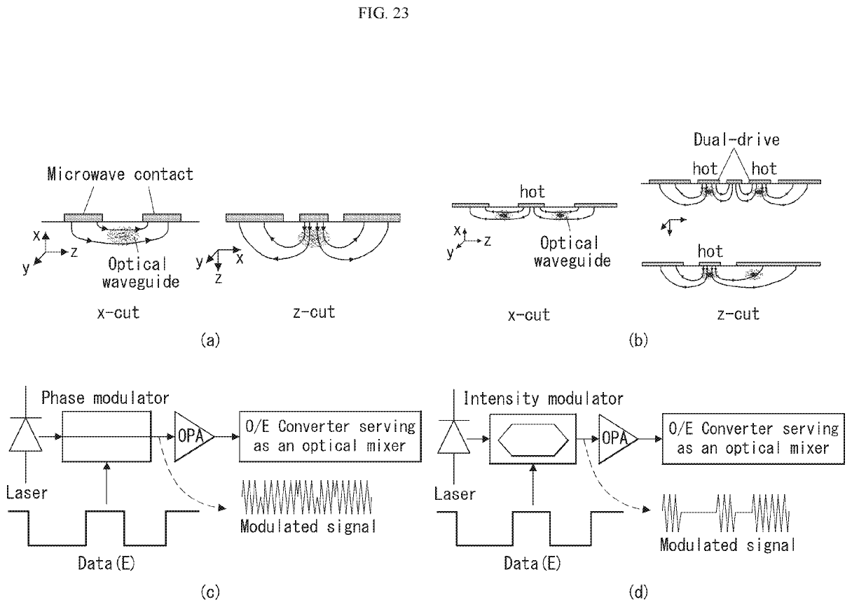

FIG. 22 illustrates a structure of a transmitter applicable to the present disclosure. FIG. 23 illustrates a structure of a modulator applicable to the present disclosure.

Referring to FIGS. 22 and 23, an optical source of a laser may change a phase of a signal by passing through an optical wave guide. In this instance, data is carried by changing electrical characteristics through a microwave contact, or the like. Thus, an optical modulator output is formed in the form of a modulated waveform. A photoelectric modulator (O/E converter) may generate THz pulses based on an optical rectification operation by a nonlinear crystal, a photoelectric conversion (O/E conversion) by a photoconductive antenna, and emission from a bunch of relativistic electrons. The THz pulse generated in the above manner may have a length of a unit from femto second to pico second. The photoelectric converter (O/E converter) performs down-conversion using non-linearity of the device.

Considering THz spectrum usage, multiple contiguous GHz bands are likely to be used as fixed or mobile service usage for the terahertz system. According to outdoor scenario criteria, an available bandwidth may be classified based on oxygen attenuation 10\hat{ }2 dB/km in the spectrum of up to 1 THz. Hence, a framework in which the available bandwidth consists of several band chunks may be considered. As an example of the framework, if the length of the THz pulse for one carrier is set to 50 ps, the bandwidth (BW) is about 20 GHz.

The effective down-conversion from the infrared band to the THz band depends on how to utilize the nonlinearity of the photoelectric converter (O/E converter). That is, for down-conversion into a desired THz band, design of the photoelectric converter (O/E converter) having the most ideal non-linearity to move to the corresponding THz band is required. If a photoelectric converter (O/E converter) which is not suitable for a target frequency band is used, there is a high possibility that an error occurs with respect to an amplitude and a phase of the corresponding pulse.

In a single carrier system, a THz transmission/reception system may be implemented using one photoelectric converter. In a multi-carrier system, as many photoelectric converters as the number of carriers may be required, which may vary depending on the channel environment. Particularly, in a multi-carrier system using multiple broadbands according to the plan related to the above-described spectrum usage, the phenomenon will be prominent. In this regard, a frame structure for the multi-carrier system may be considered. A down-frequency-converted signal based on the photoelectric converter may be transmitted in a specific resource area (e.g., a specific frame). The frequency domain of the specific resource area may include a plurality of chunks. Each chunk may consist of at least one component carrier (CC).

The wireless communication technology implemented in the wireless devices 200a and 200b according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names. Additionally or alternatively, the wireless communication technology implemented in the wireless devices 200a and 200b according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names. Additionally or alternatively, the wireless communication technology implemented in the wireless devices 200a and 200b according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

The symbols/abbreviations/terms used in the present disclosure are as follows.
D-MIMO: Distributed massive Multiple Input Multiple Output
AP: Access Point
CPU: Central Processing Unit
CSI: Channel State Information
UE: User Equipment
ToA: Time of Arrival
RSRP: Reference Signals Received Power
OOB: Out-of-band
SSB: Synchronization Signal Block
RSC: Resource
GPS: Global Positioning System
B6G: Below 6 GHz
mmWave: millimeter wave
THz: terahertz

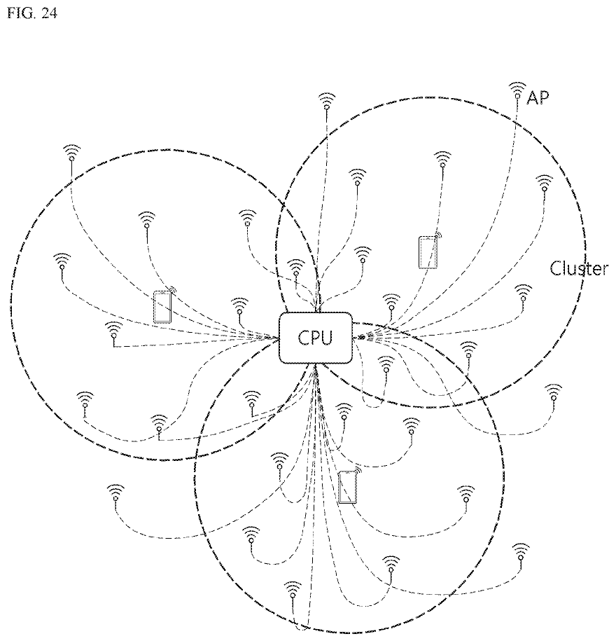

FIG. 24 illustrates an example of a distributed multiple input multiple output (D-MIMO) system applicable to the present disclosure. FIG. 25 illustrates an example of a frame structure in a D-MIMO system applicable to the present disclosure.

Referring to FIG. 24, the D-MIMO system may be a system in which a large number of geographically distributed antennas cooperate using a single time-frequency resource with the help of a fronthaul network and a central processing unit (CPU) to serve a small number of UEs.

In the D-MIMO system, there is no cell boundary in a traditional sense. Therefore, all APs on the D-MIMO system operate as if the APs are within the same cell. When a concept of the D-MIMO system was initially developed, it started with all APs servicing all UEs. However, there is a problem that APs that are far from the UEs in the D-MIMO system use only transmission power without contributing to improving signal quality of the UEs, thereby reducing efficiency of the system.

To solve this problem, a concept of a user-centric cluster, in which only APs close to the UEs provide services to the UEs, was introduced to the D-MIMO system. In the D-MIMO system, uplink and downlink may be multiplexed in a time domain. Further, it is assumed that the number of APs is much greater than the number of UEs in the D-MIMO system.

Referring to FIG. 25, transmission and reception operations of the D-MIMO system may include three steps: 1) uplink channel estimation, 2) downlink data transmission, and 3) uplink data transmission. The operations are performed within a coherence time of the channel, and therefore it is assumed that the channel remains the same while the operations are performed. The coherence time may be a coherence interval. It is also assumed that channel reciprocity, in which an uplink channel and a downlink channel are the same, is established. The steps 1) to 3) are described in detail below.

### 1) Uplink Channel Estimation

A UE transmits an assigned reference signal to an AP. Each AP receives the reference signal transmitted by the UE. Each AP estimates a channel between the UE and each AP.

### 2) Downlink Data Transmission

Each AP performs channel-matched precoding on data to be transmitted using the channel estimated in the 1). That is, each AP multiplies the data to be transmitted by a complex conjugate of the channel estimated in the uplink. Each AP transmits precoded data to the UE. The data transmitted by each AP cancels the channel by the precoding while it passes through the channel. The UE receives the data from each AP. In this case, the UE receives the data transmitted by each AP in-phase.

### 3) Uplink Data Transmission

The UE transmits uplink data to the APs. The UE may not perform the precoding on the data. The APs receive the data from the UE. The APs generate an estimate value of the received data using the channel estimated in the 1). Each AP transmits the generated estimate value to the CPU. The CPU receives the estimate value from each AP. The CPU may combine the estimate values. The CPU performs decoding on the data based on the combined estimate value.

### Joint Transmission

Joint transmission refers to a scheme in which multiple APs cooperate to transmit data to a UE. The joint transmission can improve the quality of signals received by the UE from the multiple APs and reduce interference of signals transmitted by the multiple APs to another UE.

For such an operation, sharing of data and panel information (e.g., CSI) to be transmitted to the UE is required between geographically distributed APs participating in the joint transmission. Therefore, high backhaul connection performance is required between the APs. For example, the high backhaul connection performance may mean low transmission delay and large transmission capacity of the backhaul connection between the APs.

The joint transmission scheme may be classified into a non-coherent joint transmission scheme and a coherent joint transmission scheme. In the non-coherent joint transmission, the APs share and transmits the same data, but may independently perform precoding. Therefore, the UE may obtain only a power gain. On the other hand, in the coherent joint transmission, the APs may receive channel state information (CSI) from the UE and perform precoding so that in-phase coupling can be performed at the UE based on the CSI. The UE may receive signals from each of the APs and perform coherent coupling on the signals. Therefore, the UE can obtain additional signal gain.

### User-Centric AP Clustering of D-MIMO System

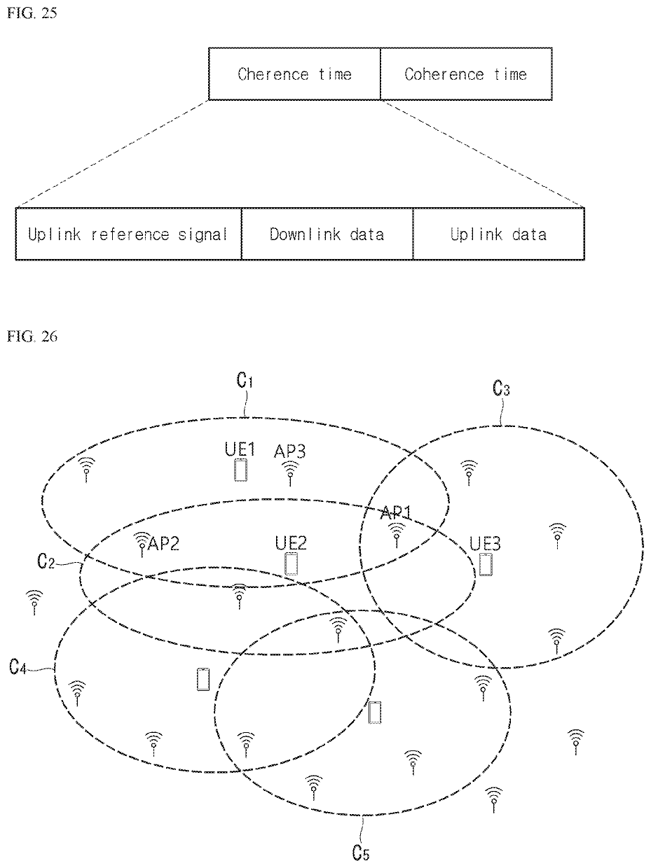

FIG. 26 illustrates an example of UE-centric AP clustering applicable to the present disclosure.

A biggest difference between the D-MIMO system and the existing cellular system is that the existing cellular system is configured such that a UE selects and accesses an optimal cell among several cells, and one UE is served by one cell, and the D-MIMO system is configured such that the UE is served by multiple APs around the UE, not one cell.

A set of APs serving the UE is called an AP cluster, and a method of forming an AP cluster roughly includes network-centric AP clustering and UE-centric AP clustering. The network-centric AP clustering is configured such that each AP cluster includes a set of non-overlapping, mutually exclusive APs, and the APs constituting the AP cluster serve UEs within the AP cluster.

There is no cell boundary in the cluster, but inter-cluster interference may occur at a boundary between the clusters. On the other hand, the UE-centric AP clustering forms an AP cluster by selecting APs that serve each UE by each UE.

In the UE-centric AP clustering, serving APs may overlap between contiguous UEs, and thus clusters of the APs may also overlap each other. For example, referring to FIG. 25, since AP1 belongs to a cluster C1 of UE1, a cluster C2 of UE2, and a cluster C3 of UE3, the AP1 serves all the UE1, the UE2, and the UE3. In the UE-centric AP clustering, because the UE is always located at a center of the cluster, the UE-centric AP clustering can prevent a situation where the UE is located at a cluster boundary and is greatly affected by inter-cluster interference. In the UE-centric AP clustering, a cell boundary concept in the traditional sense disappears, and the connection quality between the UE and the AP is periodically checked to update the AP cluster serving the corresponding UE.

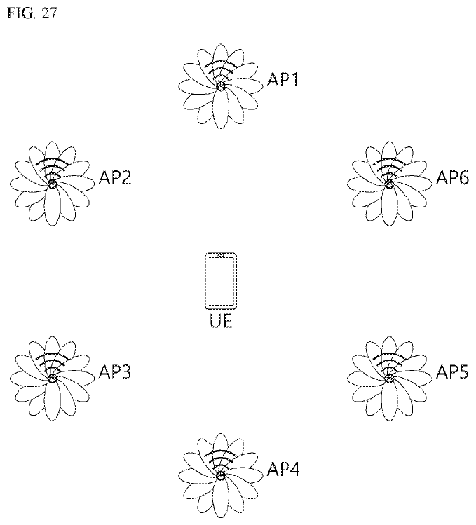

FIG. 27 illustrates an example of initial access in a D-MIMO system applicable to the present disclosure.

FIG. 27 illustrates an example of beam-formed initial access in mmWave/THz band. The biggest problem facing mmWave\MHz band transmission systems is a reduction in a signal strength due to path attenuation, which increases as a carrier frequency of a transmission signal increases. To overcome the path attenuation, the mmWave\THz band transmission systems use beamforming using multiple antennas.

In other words, a phase value of each antenna element may be appropriately set so that the transmission signals are concentrated in a specific direction by using multiple antenna elements, thereby increasing an antenna gain.

The antenna beamforming may be used at both a transmitter and a receiver. When the UE and the APs use the antenna beamforming, a beam alignment process of aligning beam directions between the UE and the APs is required in the initial access process.

In the 3GPP NR standard, a method was introduced in which the AP applies different beamformings to synchronization signal blocks (SSBs) for beam alignment in the initial access process to periodically transmit the SSBs, and the UE finds an optimal beam among the SSBs and performs the initial access. In this process, the AP transmits all beams that can be served when transmitting the SSBs.

If the method is introduced to the D-MIMO system as it is, the UE shall search all beams of all APs that the UE intends to access. Accordingly, time required for the initial access increases by the number of searchable APs. In addition, since each AP shall periodically transmit all the beams, a system overhead may generate as a very large problem.

To address the problem, methods have been proposed to reduce a range of beams to be searched. The most representative method is to reduce a beam search range using location information of the UE. Global positioning system (GPS) information is typically used to determine the location information of the UE. However, the GPS information has a problem of being unusable in areas where shadows are caused by tall buildings, such as in urban areas, or where line of sight (LoS) with the satellite is blocked, such as indoors.

### Embodiments of the Present Disclosure

The present disclosure proposes a method of determining an approximate location of a UE without the help of GPS in a D-MIMO system and limiting a range of beams that each AP shall transmit for beam alignment between the UE and the AP to thereby reduce an overhead of the entire system.

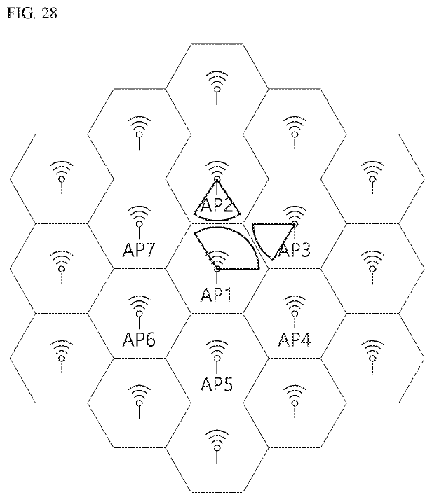

FIG. 28 illustrates an example of an initial access method according to an embodiment of the present disclosure.

FIG. 28 illustrates an example of initial access of a D-MIMO system in mmWave/Hz band using out-of-band (OOB) information according to an embodiment of the present disclosure. The present disclosure assumes that APs and UEs support both B6G (below 6G) band and mmWave/THz band.

Referring to FIG. 28, in the initial access, the UE may first find an optimal AP in the B6G band. The optimal AP may be a first AP AP1. That is, the UE may attempt to access the first AP AP1. In this instance, the UE may perform measurement on APs (second to seventh APs AP2 to AP7) around the first AP AP1. The UE may feed back a measurement result to a network. Alternatively, the UE may acquire location information from the measurement result and report the location information to the network. The location information may be approximate location information of the UE.

The network may receive feedback on the measurement result from the UE. Alternatively, the network may receive the location information from the UE. Based on the measurement result or the location information, the network may reduce a range of beams that APs (first to seventh APs AP1 to AP7) around the UE sweep for the initial access.

To this end, the network may pre-schedule resources for performing measurement on surrounding APs based on an SSB of an AP (i.e., a serving AP) that the UE intends to access in the B6G band. For example, when the UE intends to access the first AP AP1, the pre-scheduled resources for performing the measurement on the second AP AP2 to the seventh AP AP7 based on the SSB of the first AP AP1 may be as follows.

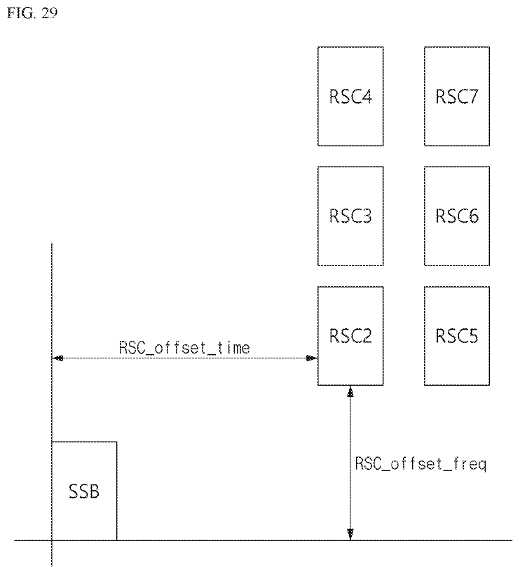

FIG. 29 illustrates an example of free-scheduled resources according to an embodiment of the present disclosure.

Referring to FIG. 29, an SSB may be an SSB resource of the first AP AP1, and RSC2 to RSC7 may be pre-scheduled resources for measuring the second AP AP2 to the seventh AP AP7. The RSC2 to RSC7 may be resources for each of the second AP AP2 to the seventh AP AP7 to transmit a reference signal to the UE.

The RSC2 may be a first pre-scheduled resource, and the RSC3 to RSC7 may be second to sixth pre-scheduled resources. The RSC2 may be pre-scheduled based on a location RSC_offset_time in a time domain and a location RSC_offset_freq in a frequency domain. The location RSC_offset_time in the time domain and the location RSC_offset_freq in the frequency domain may be preset values. The RSC3 to RSC7 may be pre-scheduled based on the RSC2 and a preset rule.

Referring again to FIG. 28, the UE may detect the SSB of the serving AP. The UE may acquire information on locations of the pre-scheduled resources based on the SSB. The UE may receive the reference signals from the surrounding APs through the pre-scheduled resources. For example, the UE may detect the SSB of the first AP AP1 and acquire information on locations of the pre-scheduled resources (e.g., RSC2 to RSC6 in FIG. 29) based on the SSB of the first AP AP1. The UE may receive the reference signal from each of the second to seventh APs AP2 to AP7 through the pre-scheduled resources.

The UE may perform measurement on the reference signals to acquire the location information. The location information may be approximate location information of the UE. For example, the UE may measure reference signals received power (RSRP) or time of arrival (ToA) for each reference signal. The UE may select a preferred AP among the surrounding APs based on the measurement values.

For example, when the number of APs that the UE can select is 2 and the UE measures the RSRP, the UE may measure the RSRP from each of the RSC2 to RSC7 of FIG. 29 and select the two RSRPs with the highest measured values. That is, the UE may measure the RSRPs of the reference signals transmitted by the second to seventh APs AP2 to AP7 through the RSC2 to RSC7 of FIG. 29 and select the two reference signals with the highest RSRP values among the reference signals. The UE may select the two APs that respectively transmit the two reference signals. The UE may select the second AP AP2 and the third AP AP3 that are close to the UE.

The UE may report information on the preferred AP to the serving AP in the B6G band. For example, the UE may report the information on the preferred AP to the serving AP by defining a new 6-bit flag field to Msg3 of a random access channel (RACH), turning on a flag of the preferred AP, and turning off flags of the remaining APs. The serving AP may report the information on the preferred AP to the network. The network may receive the information on the preferred AP from the serving AP.

For example, the UE may report information on the second AP AP2 and the third AP AP3, which are the preferred APs, to the first AP AP1 which is the serving AP. The serving AP, the first AP AP1, may report the information on the second AP AP2 and the third AP AP3, which are the preferred APs, to the network.

The network may instruct the serving AP and the preferred AP to perform beam sweeping for the UE. The network may instruct the serving AP and the preferred AP to perform the beam sweeping in the mmWave/THz band. In this case, the remaining APs may not perform the beam sweeping.

For example, the network may receive the information on the second AP AP2 and the third AP AP3, which are the preferred APs, to the first AP AP1 which is the serving AP. The network may instruct the first to third APs AP1 to AP3 to perform the beam sweeping for the UE. The network may instruct the first to third APs AP1 to AP3 to perform the beam sweeping in the mmWave/THz band. In this case, the fourth to seventh APs AP4 to AP7 may not perform the beam sweeping. Therefore, the overhead of system resources and the time required for beam search can be reduced.

The approximate location of the UE may be determined based on the serving AP and the preferred AP. For example, the location of the UE may be limited to between the first AP AP1, which is the serving AP, and the second AP AP2 and the third AP AP3, which are the preferred APs. Using this, a beam search range of the first AP1 in the mmWave/THz band may be limited to an area of 120 degrees which is a direction of the second AP AP2 and the third AP AP3, and beam search ranges of the second AP AP2 and the third AP AP3 may be limited to an area of 60 degrees which is a direction of the first AP APL. In this case, the beam search range of the first AP AP1 can be reduced by 66%, and the beam search ranges of the second AP AP2 and the third AP AP3 can be reduced by 84%.

The network may select APs to perform the beam sweeping based on the location information of the UE. The APs to perform the beam sweeping may include at least one of multiple APs. For example, the APs to perform the beam sweeping may include a serving AP and APs preferred by the UE, or may include some of remaining APs excluding the serving AP and the APs preferred by the UE from the multiple APs, or may include some of the serving AP and the APs preferred by the UE and some of the remaining APs excluding the serving AP and the APs preferred by the UE. In addition, the network may determine a beam sweeping range of the APs to perform the beam sweeping based on the location information of the UE.

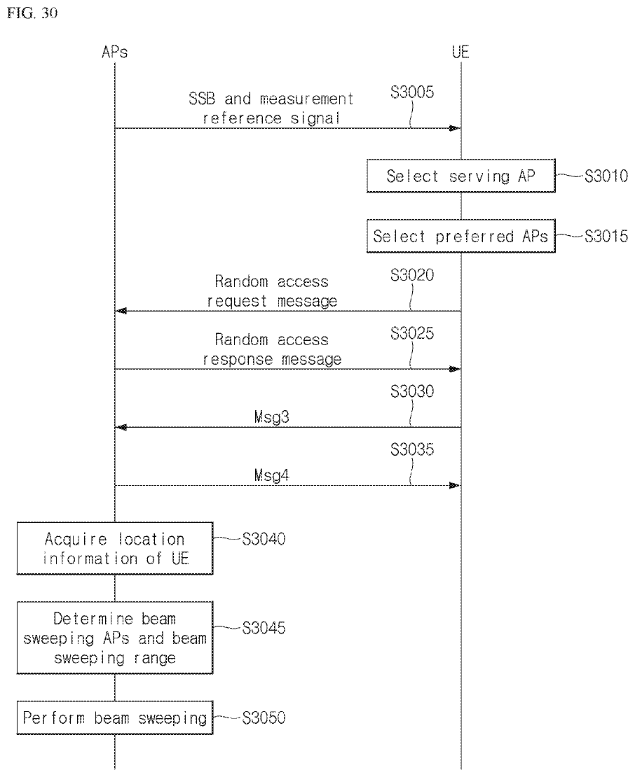

FIG. 30 is a flowchart illustrating a beam search method according to an embodiment of the present disclosure.

FIG. 30 illustrates an example of a procedure where the UE selects a preferred AP using pre-scheduled resources and reports the preferred AP to a network to limit a beam search range of the preferred AP in the mmWaverTHz band.

Referring to FIG. 30, multiple APs may transmit SSBs and measurement reference signals to the UE, in S3005. The measurement reference signals may be pre-scheduled. The UE may receive the SSBs and the measurement reference signals from the multiple APs, in S3005.

The UE may select a serving AP, in S3010. The serving AP may be an optimal AP. The UE may measure RSRPs of the SSBs. The UE may select an AP that transmits an SSB with a highest RSRP value among the multiple APs, as the serving AP.

The UE may select preferred APs, in S3015. The preferred APs may be APs preferred by the UE. The UE may know a location of pre-scheduled resources based on a location of SSB resources transmitted by the serving AP. A relationship between the location of the SSB resources and the location of the pre-scheduled resources may be pre-configured in the standard and thus may be known to the UE in advance. The UE may receive a reference signal from some of the multiple APs through the pre-scheduled resources. Some of the multiple APs may be APs located around the serving AP among the multiple APs of S3005. The UE may select the preferred APs by performing a measurement on the reference signal.

The UE may transmit a random access request message to the serving AP, in S3020. The UE may transmit the random access request message to the serving AP in the B6G band.

The serving AP may receive the random access request message from the UE, in S3020. The serving AP may receive the random access request message from the UE in the B6G band.

The serving AP may transmit a random access response message to the UE, in S3025. The serving AP may transmit the random access response message to the UE in response to the random access request message. The serving AP may transmit the random access response message to the UE in the B6G band.

The UE may receive the random access response message from the serving AP, in S3025. The UE may receive the random access response message from the serving AP in the B6G band.

The UE may transmit Msg3 to the serving AP, in S3030. The UE may transmit the Msg3 to the serving AP in response to the random access response message. The UE may transmit the Msg3 to the serving AP in the B6G band. The Msg3 may include information on the preferred APs selected by the UE in S3015.

The serving AP may receive the Msg3 from the UE, in S3030. The serving AP may receive the Msg3 from the UE in the B6G band.

The serving AP may transmit Msg4 to the UE, in S3035. The serving AP may transmit the Msg4 to the UE in response to the Msg3. The UE may receive the Msg4 from the serving AP, in S3035.

The serving AP may acquire location information of the UE, in S3040. The serving AP may acquire information on the preferred APs through the Msg3 received in S3030. The serving AP may acquire the location information of the UE based on a location of the serving AP and locations of the preferred APs. The location information may be approximate location information of the UE. Alternatively, the serving AP may receive the location information of the UE from the network.

The serving AP may determine beam sweeping APs and beam sweeping ranges of the beam sweeping APs, in S3045. The serving AP may determine beam sweeping APs, which are APs to perform the beam sweeping, among the multiple APs based on the location information of the UE. The beam sweeping APs may include at least one of the multiple APs. The serving AP may determine the beam sweeping ranges of the beam sweeping APs based on the location information of the UE.

The beam sweeping APs may perform the beam sweeping, in 53050. The serving AP may transmit information on the beam sweeping ranges acquired in S3040 to the beam sweeping APs. The beam sweeping APs may perform the beam sweeping based on the information on the beam sweeping ranges.

Alternatively, the beam sweeping APs may receive information on the beam sweeping ranges from the network and perform the beam sweeping based on the information. The beam sweeping APs may perform the beam sweeping in a limited range. The beam sweeping APs may perform the beam sweeping in the mmWave\Hz band.

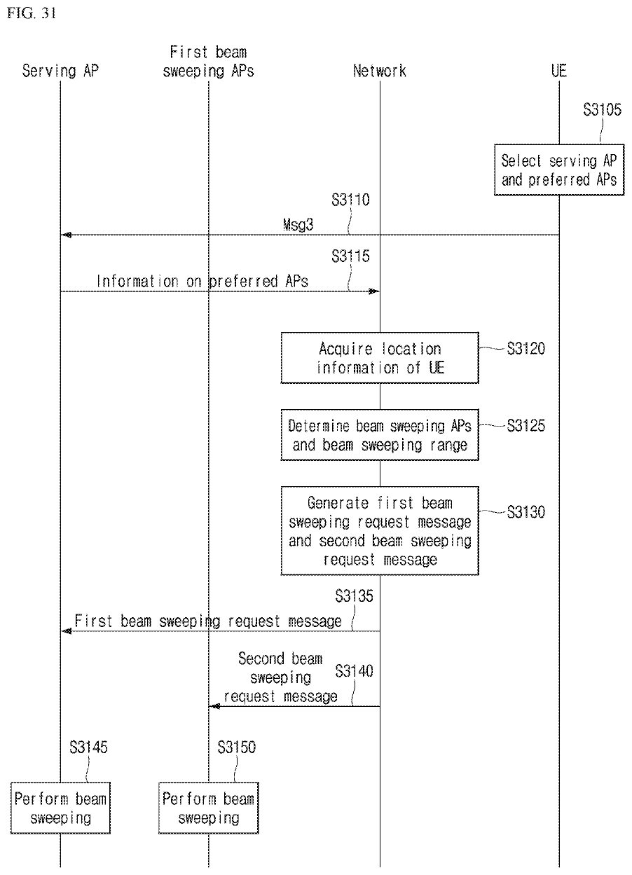

FIG. 31 is a flowchart illustrating a beam search method according to another embodiment of the present disclosure.

In FIG. 31, the network may include a network controller or a central processor unit (CPU).

Referring to FIG. 31, a UE may select a serving AP and preferred APs from among multiple APs, in S3105. The serving AP may be an optimal AP. The preferred APs may be APs preferred by the UE. The UE may receive SSBs and measurement reference signals from the multiple APs. The measurement reference signals may be pre-scheduled. The UE may measure RSRPs of the SSBs. The UE may select an AP that transmits a signal with a highest RSRP measured value among the multiple APs, as the serving AP. The UE may know a location of pre-scheduled resources based on a location of SSB resources transmitted by the serving AP. A relationship between the location of the SSB resources and the location of the pre-scheduled resources may be pre-configured in the standard and thus may be known to the UE in advance. The UE may receive a reference signal from some of the multiple APs through the pre-scheduled resources. Some of the multiple APs may be APs located around the serving AP among the multiple APs transmitting the SSB. The UE may select the preferred APs by performing a measurement on the reference signal.

The UE may transmit Msg3 including information on the preferred APs to the serving AP, in S3110. The UE may transmit a random access request message to the serving AP and receive a random access response message from the serving AP in response to the random access request message. The UE may transmit the Msg3 including the information on the preferred APs in response to the random access response message. The UE may transmit the information on the preferred APs to the serving AP in the B6G band.

The serving AP may receive the Msg3 including the information on the preferred APs from the UE, in S3110. The serving AP may receive the information on the preferred APs from the UE in the B6G band. The serving AP may transmit the information on the preferred APs to the network, in S3115.

The network may receive the information on the preferred APs from the serving AP, in S3115. The network may acquire location information of the UE, in S3120. The network may acquire the location information of the UE based on a location of the serving AP and locations of the preferred APs. The location information may be approximate location information of the UE.

The network may determine beam sweeping APs and beam sweeping ranges of the beam sweeping APs, in S3125. The network may determine beam sweeping APs, which are APs to perform the beam sweeping, among the multiple APs based on the location information of the UE. The beam sweeping APs may include at least one of the multiple APs. The network may determine the beam sweeping ranges of the beam sweeping APs based on the location information of the UE.

The network may generate a first beam sweeping request message and a second beam sweeping request message, in S3130. The first beam sweeping request message may include information on a beam sweeping range of the serving AP, and the second beam sweeping request message may include information on beam sweeping ranges of first beam sweeping APs. The first beam sweeping APs may be APs excluding the serving AP from the beam sweeping APs determined in S3125. If the serving AP is not included in the beam sweeping APs determined in S3125, the first beam sweeping APs may be the same as the beam sweeping APs determined in S3125, and the network may not generate the first beam sweeping request message.

The network may transmit the first beam sweeping request message to the serving AP, in S3135. The serving AP may receive the first beam sweeping request message from the network, in S3135. The serving AP may perform beam sweeping, in S3145. The serving AP may perform the beam sweeping based on information on the beam sweeping range included in the first beam sweeping request message. The serving AP may perform the beam sweeping in a limited range. The serving AP may perform the beam sweeping in the mmWave/THz band. If the first beam sweeping request message is not generated in S3130, the steps S3135 and S3145 may be omitted.

The network may transmit the second beam sweeping request message to the first beam sweeping APs, in S3140. The first beam sweeping APs may receive the second beam sweeping request message from the network, in S3140. The first beam sweeping APs may perform the beam sweeping, in S1350. The first beam sweeping APs may perform the beam sweeping based on information on the beam sweeping range included in the second beam sweeping request message. The first beam sweeping APs may perform the beam sweeping in a limited range. The first beam sweeping APs may perform the beam sweeping in the mmWave/THz band.

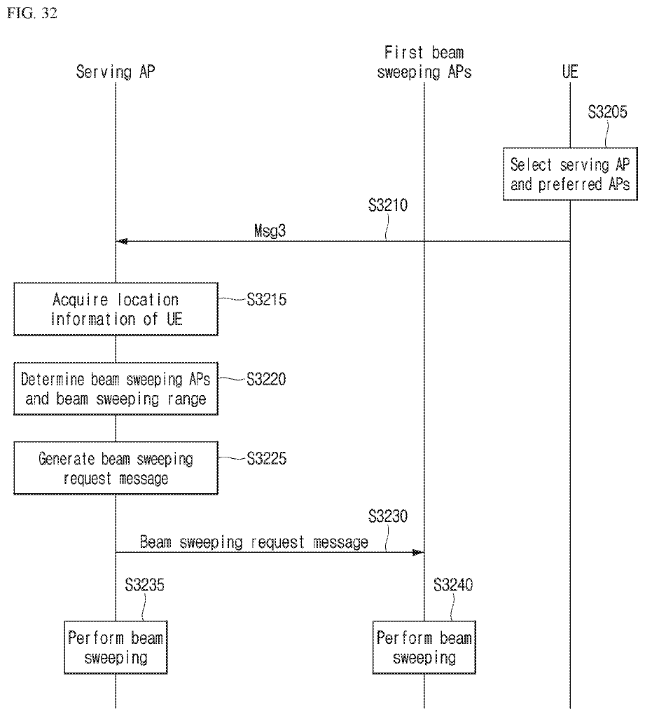

FIG. 32 is a flowchart illustrating a beam search method according to another embodiment of the present disclosure.

Referring to FIG. 32, a UE may select a serving AP and preferred APs from among multiple APs, in S3205. The serving AP may be an optimal AP. The preferred APs may be APs preferred by the UE. The UE may receive SSBs and measurement reference signals from the multiple APs. The measurement reference signals may be pre-scheduled. The UE may measure RSRPs of the SSBs. The UE may select an AP that transmits a signal with a highest RSRP measured value among the multiple APs, as the serving AP. The UE may know a location of pre-scheduled resources based on a location of SSB resources transmitted by the serving AP. A relationship between the location of the SSB resources and the location of the pre-scheduled resources may be pre-configured in the standard and thus may be known to the UE in advance. The UE may receive a reference signal from some of the multiple APs through the pre-scheduled resources. Some of the multiple APs may be APs located around the serving AP among the multiple APs transmitting the SSB. The UE may select the preferred APs by performing a measurement on the reference signal.

The UE may transmit Msg3 including information on the preferred APs to the serving AP, in S3210. The UE may transmit a random access request message to the serving AP and receive a random access response message from the serving AP in response to the random access request message. The UE may transmit the Msg3 including the information on the preferred APs in response to the random access response message. The UE may transmit the information on the preferred APs to the serving AP in the B6G band.

The serving AP may receive the Msg3 including the information on the preferred APs from the UE, in S3210. The serving AP may receive the information on the preferred APs from the UE in the B6G band.

The serving AP may acquire location information of the UE, in S3215. The serving AP may acquire the location information of the UE based on a location of the serving AP and locations of the preferred APs. The location information may be approximate location information of the UE.

The serving AP may determine beam sweeping APs and beam sweeping ranges of the beam sweeping APs, in S3220. The serving AP may determine the beam sweeping APs based on the location information of the UE acquired in S3215. The beam sweeping APs may include at least one of the multiple APs. The serving AP may determine the beam sweeping ranges of the beam sweeping APs based on the location information of the UE.

The serving AP may generate a beam sweeping request message, in S3225. The beam sweeping request message may include information on beam sweeping ranges of first beam sweeping APs. The first beam sweeping APs may be APs excluding the serving AP from the beam sweeping APs determined in S3220. If the serving AP is not included in the beam sweeping APs determined in S3220, the first beam sweeping APs may be the same as the beam sweeping APs determined in S3220. The beam sweeping request message may include the information on the beam sweeping ranges of the first beam sweeping APs determined in S3220.

The serving AP may transmit the beam sweeping request message to the first beam sweeping APs, in S3230. The serving AP may transmit the beam sweeping request message to the first beam sweeping APs via Xn interface.

The first beam sweeping APs may receive the beam sweeping request message from the serving AP, in S3230. The first beam sweeping APs may receive the beam sweeping request message from the serving AP via Xn interface.

The serving AP may perform beam sweeping, in S3235. The serving AP may perform the beam sweeping based on the information on the beam sweeping ranges determined in S3220. The serving AP may perform the beam sweeping in a limited range. The serving AP may perform the beam sweeping in the mmWave\THz band. If the serving AP is not included in the beam sweeping APs determined in S3220, the step S3235 may be omitted.

The first beam sweeping APs may perform beam sweeping, in S3240. The first beam sweeping APs may acquire information on the beam sweeping ranges from the beam sweeping request message. The first beam sweeping APs may perform the beam sweeping based on the information on the beam sweeping ranges. The first beam sweeping APs may perform the beam sweeping in a limited range. The first beam sweeping APs may perform the beam sweeping in the mmWave/THz band.

FIGS. 31 and 32 illustrate the procedures that are distinguished based on whether there is a network (e.g., CPU) controlling all the APs or whether each AP has a certain processing capability and is capable of local processing. In the former case, since the network performs the necessary processing, controls each AP, and transmits the necessary information, there is an advantage in that the structure of each AP becomes simpler. However, in all the procedures, information is first transmitted to the CPU and the CPU performs processing, and then information and operation instructions are transmitted to each AP, and thus the delay may occur. On the other hand, in the latter case, the delay in information transmission is reduced, but the processing capability required for each AP increases, which may increase the complexity of the AP.

The locations of the pre-scheduled resources described in the present disclosure may be predefined based on the SSB of the first AP (i.e., the serving AP). However, the number of APs around the first AP that the UE shall measure may vary depending on an environment in which the APs are installed. Therefore, a method of signaling the number of APs that the UE shall measure is required. The information may be included in a system information block (SIB). However, in this case, there is a disadvantage in that since the UE shall decode the SIB so as to measure the resources, a time delay occurs in which the UE shall wait for a next frame after receiving the SSB. In addition, a master information block (MIB) transmitted via the PBCH may be insufficient in capacity because the number of reserved bits in the current NR standard is 1 bit. The present disclosure proposes a method of signaling the number of resources to be measured without affecting existing UEs.

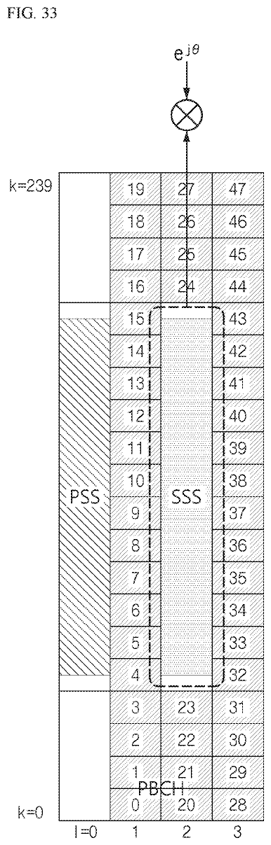

FIG. 33 illustrates an example of a signaling method according to an embodiment of the present disclosure.

FIG. 33 illustrates a method of signaling the number of resources using phase modulation described in the present disclosure. An SSB defined in the 3GPP NR includes PSS, SSS, and PBCH. The present disclosure proposes a method of signaling the number of resources by applying the phase modulation to the SSS.

If a transmitter applies phase modulation to the SSS and transmits it, a receiver may obtain a phase value multiplied by the SSS by calculating a phase difference between the SSS and the PSS. If the channels are maintained the same within the SSB, that is, if phases due to the channels of the PSS and the SSS are the same, the phase difference between the PSS and the SSS may be the phase value multiplied by the SSS.

For example, when signaling is performed using the phase difference between the PSS and the SSS, the signaling value may be expressed as shown in Table 6 below.

TABLE 6

| PBCH Phase | |
|---|---|
| Modulation | |
| (θ) | Signaling Interpretation |
| 0 | D-MIMO incapable cell |
| π/4 | D-MIMO capable cell/# of Meas. Rsc. = A |
| π/2 | D-MIMO capable cell/# of Meas. Rsc. = B |
| 3π/4 | D-MIMO capable cell/# of Meas. Rsc. = C |

The above embodiment is implemented only if the channels experienced by the PSS and the SSS are the same. However, even if the actual transmission channels experienced by the PSS and the SSS are the same, the channels of the PSS and the SSS received by the UE are not the same. This is that the PSS is transmitted as one value of cell groups 0, 1, and 2, and the SSS is transmitted as a value between 0 and 335 because of physical cell IDs transmitted using the PSS and the SSS.

Therefore, for the PSS, there is a high probability that the same value is being used in contiguous cells, and accordingly, the channel experienced by the PSS appears to have more multipath components than the SSS. For this reason, the assumption that the PSS and the SSS have experienced the same channel is not established, and performance degradation may occur when restoring the phase value multiplied by the SSS from the phase difference between the PSS and the SSS.

If a received signal includes a residual frequency offset, there is a problem in that a phase resulting from the frequency offset cannot be separated from a phase multiplied during transmission. To solve the problem, the phase modulation can be applied to the entire PBCH in the embodiment. This is described in detail below.

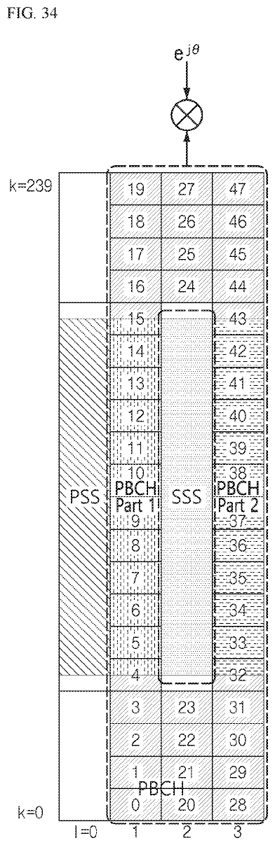

FIG. 34 illustrates an example of a signaling method according to another embodiment of the present disclosure.

If a phase value multiplied by PBCH is θ and a phase difference between OFDM symbols due to a residual frequency offset is Oo, a phase difference between SSS and DMRS of PBCH part 1 may be θo−0 In addition, a phase difference between PBCH part 2 and the SSS may be θo+θ. When a difference between the two phase differences is calculated, the residual frequency offset θo disappears and only 2θ, which is a phase-modulated component of the PBCH, remains.

For example, when signaling is performed using the phase difference between the PBCH and the SSS, the signaling value may be expressed as shown in Table 7 below.

TABLE 7

| PBCH | | | | |
|---|---|---|---|---|
| Phase | P1: “Phase of | | | |
| Modu- | SSS” − “Phase | P2: “Phase | | |
| lation | of PBCH | of PBCH part2” − | P2 − P1 | Signaling |
| (θ) | part1” | “Phase of SSS” | (2θ) | Interpretation |
| 0 | θ₀ | θ₀ | 0 | D-MIMO |
| | | | | incapable cell |
| π/4 | θ₀ − π/4 | θ₀ + π/4 | π/2 | D-MIMO capable |
| | | | | cell/# of Meas. |
| | | | | Rsc. = A |
| π/2 | θ₀ − π/2 | θ₀ + π/2 | π | D-MIMO capable |
| | | | | cell/# of Meas. |
| | | | | Rsc. = B |
| 3π/4 | θ₀ − 3π/4 | θ₀ + 3π/4 | 3π/2 | D-MIMO capable |
| | | | | cell/# of Meas. |
| | | | | Rsc. = C |

Since the phase component θ multiplied by the PBCH is multiplied by the entire PBCH, the phase component by θ is also reflected in the channel estimated from the DMRS of the PBCH, and since the PBCH is decoded using the estimated channel, the existing receiver may not be affected.

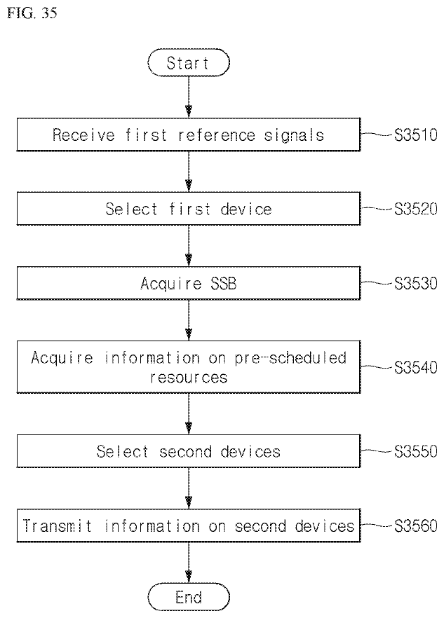

FIG. 35 is a flowchart illustrating a beam search method according to an embodiment of the present disclosure.

In FIG. 35, a first device may be the serving AP described above, and a second device may be the preferred AP described above.

Referring to FIG. 35, a UE may receive first reference signals, in S3510. The UE may receive the first reference signals from each of a plurality of devices. The first reference signals may include SSB and a pre-scheduled measurement reference signal.

The UE may select the first device based on the first reference signals, in S3520. The UE may select the first device among the plurality of devices. The UE may perform a measurement on the first reference signals. The UE may select the first device based on a measurement value. For example, the UE may measure RSRPs for the first reference signals. The UE may select a device, that transmits a first reference signal with a highest RSRP value among the plurality of devices, as the first device.

The UE may acquire an SSB, in S3530. The UE may acquire the SSB based on the first reference signal received from the first device among the first reference signals acquired in S3510.

In an embodiment, the SSB may include a PSS, an SSS, and a PBCH. The SSS may be phase-modulated.

In another embodiment, the SSB may include a PSS, an SSS, a first PBCH, and a second PBCH. A phase difference between the first PBCH and the second PBCH may be related to a phase modulation value of the first PBCH or the second PBCH.

The UE may acquire information on pre-scheduled resources based on the SSB, in S3530.

In an embodiment, the UE may acquire the PSS, the SSS, and the PBCH from the SSB, acquire a phase difference value between the PSS and the SSS, acquire a phase modulation value of the PBCH based on the phase difference value, and acquire information on the number of the pre-scheduled resources based on the phase modulation value.

In another embodiment, the UE may acquire the PSS, the SSS, the first PBCH, and the second PBCH from the SSB, acquire a phase difference value between a DMRS of the first PBCH and a DMRS of the second PBCH, and acquire information on the number of pre-scheduled resources based on the phase difference value.

The UE may select second devices, in S3540. The UE may select the second devices among the plurality of devices. The UE may select at least one second device based on the information on the pre-scheduled resources acquired in S3530. The UE may receive second reference signals from the plurality of devices via the pre-scheduled resources. The UE may perform a measurement on the second reference signals. The UE may select the second devices among the plurality of devices based on a result of performing the measurement. For example, the UE may measure RSRP or ToA of the second reference signals and select the second devices among the plurality of devices based on measurement values.

The UE may transmit information on the second devices to the first device, in S3550. The UE may transmit the information on the second devices selected in S3540 to the first device. The UE may transmit a random access request message to the first device, receive a random access response message from the first device, transmit Msg3 including the information on the second devices to the first device, and receive the Msg4 from the first device.

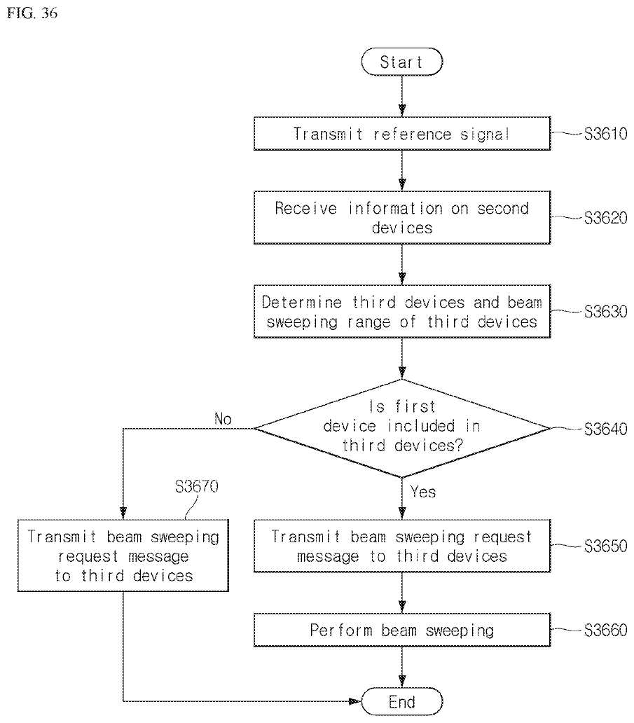

FIG. 36 is a flowchart illustrating a beam search method according to another embodiment of the present disclosure.

In FIG. 36, a first device may be the serving AP described above, a second device may be the preferred AP described above, and a third device may be a beam sweeping AP.

The first device may transmit a reference signal to a UE, in S3610. The first device may transmit the reference signal to the UE in a first band. The first band may be B6G band. In an embodiment, the reference signal may include an SSB including a PSS, an SSS, and a PBCH, and the SSS may be phase-modulated. In another embodiment, the reference signal may include an SSB including a PSS, an SSS, a first PBCH, and a second PBCH, and a phase difference between a DMRS of the first PBCH and a DMRS of the second PBCH may be related to a phase modulation value of the first PBCH or the second PBCH.

The first device may receive information on second devices from the UE, in S3620. The information on the second devices may include location information of the second devices. The first device may receive a random access request message from the UE in the first band, transmit a random access response message to the UE in the first band, and receive Msg3 including the information on the second devices from the UE in the first band.

The first device may select third devices and determine a beam sweeping range of the third devices, in S3630. The first device may acquire location information of the UE based on location information of the first device and the location information of the second devices. The location information of the UE may be approximate location information of the UE. The first device may select the third devices based on the location information of the UE. The first device may determine the beam sweeping range of the third devices based on the location information of the UE.

The first device may determine whether the third devices include the first device, in S3640. If the third devices include the first device (‘Yes’ in S3640), the first device may transmit a beam sweeping request message to the third devices, in S3650. The first device may generate the beam sweeping request message including information on the beam sweeping range determined in S3630. The first device may transmit the beam sweeping request message to the third devices. The first device may transmit the beam sweeping request message to the third devices via Xn interface.

The first device may perform a beam sweeping based on the beam sweeping range determined in S3630, in 3660. The first device may perform the beam sweeping in a second band. The second band may include at least one of a mmWave band or a THz band.

If the third devices do not include the first device (‘No’ in S3640), the first device may transmit a beam sweeping request message to the third devices, in S3670. The first device may generate the beam sweeping request message including the information on the beam sweeping range determined in S3630. In this case, the first device may not perform a separate beam sweeping. The first device may transmit the beam sweeping request message to the third devices. The first device may transmit the beam sweeping request message to the third devices via the Xn interface.

The above description can be applied in combination with embodiments of the present disclosure described below, or can be supplemented to clarify the technical features of embodiments of the present disclosure. It is obvious that embodiments described below are merely distinguished for convenience of description, and some configurations of an embodiment can be substituted with some configurations of another embodiment, or can be combined and applied.

The embodiments described above are implemented by combinations of components and features of the present disclosure in predetermined forms. Each component or feature should be considered selectively unless specified separately. Each component or feature can be carried out without being combined with another component or feature. Moreover, some components and/or features are combined with each other and can implement embodiments of the present disclosure. The order of operations described in embodiments of the present disclosure can be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the above detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

1. A method of operating a user equipment (UE) in a wireless communication system, the method comprising:
receiving first reference signals from a plurality of devices;
performing a measurement on the first reference signals to select a first device among the plurality of devices;
acquiring a synchronization signal block (SSB) based on a first reference signal received from the first device among the first reference signals;
acquiring information on pre-scheduled resources based on the SSB;
selecting second devices among the plurality of devices based on the information on the pre-scheduled resources; and
transmitting information on the second devices to the first device.

2. The method of claim 1, wherein acquiring the information on the pre-scheduled resources based on the SSB comprises:
acquiring a primary synchronization signal (PSS), a secondary synchronization signal (SSS), and a physical broadcast channel (PBCH) from the SSB;
obtaining a phase difference value between the PSS and the SSS;
obtaining a phase modulation value of the PBCH based on the phase difference value; and
acquiring information on a number of the pre-scheduled resources based on the phase modulation value.

3. The method of claim 1, wherein acquiring the information on the pre-scheduled resources based on the SSB comprises:
acquiring a primary synchronization signal (PSS), a secondary synchronization signal (SSS), a first physical broadcast channel (PBCH), and a second PBCH from the SSB;
obtaining a phase difference value between a demodulation reference signal (DMRS) of the first PBCH and a DMRS of the second PBCH; and
acquiring information on a number of the pre-scheduled resources based on the phase difference value.

4. The method of claim 1, wherein selecting the second devices among the plurality of devices based on the information on the pre-scheduled resources comprises:
receiving second reference signals from the plurality of devices via the pre-scheduled resources;
performing a measurement on the second reference signals; and
selecting the second devices among the plurality of devices based on a result of performing the measurement on the second reference signals.

5. The method of claim 1, wherein transmitting the information on the second devices to the first device comprises:
transmitting a random access request message to the first device;
receiving a random access response message from the first device; and
transmitting Msg3 including the information on the second devices to the first device.

6. A user equipment (UE) operating in a wireless communication system, the UE comprising:
one or more transceivers;
one or more processors controlling the one or more transceivers; and
a memory including one or more instructions performed by the one or more processors,
wherein the one or more instructions comprise:
receiving first reference signals from a plurality of devices;
performing a measurement on the first reference signals to select a first device among the plurality of devices;
acquiring a synchronization signal block (SSB) based on a first reference signal received from the first device among the first reference signals;
acquiring information on pre-scheduled resources based on the SSB;
selecting second devices among the plurality of devices based on the information on the pre-scheduled resources; and
transmitting information on the second devices to the first device.

7. A method of operating a first device in a wireless communication system, the method comprising:
transmitting, to a user equipment (UE), a reference signal in a first band;
receiving, from the UE, information on second devices in the first band;
acquiring location information of the UE based on a location of the first device and locations of the second devices;
determining third devices and a beam sweeping range of the third devices based on the location information of the UE; and
transmitting, to the third devices, a beam sweeping request message including information on the beam sweeping range.

8. The method of claim 7, wherein the reference signal includes a synchronization signal block (SSB) including a primary synchronization signal (PSS), a secondary synchronization signal (SSS), and a physical broadcast channel (PBCH), and
wherein the SSS is phase-modulated.

9. The method of claim 7, wherein the reference signal includes a synchronization signal block (SSB) including a primary synchronization signal (PSS), a secondary synchronization signal (SSS), a first physical broadcast channel (PBCH), and a second PBCH, and
wherein a phase difference between a demodulation reference signal (DMRS) of the first PBCH and a DMRS of the second PBCH is related to a phase modulation value of the first PBCH or the second PBCH.

10. The method of claim 7, wherein receiving, from the UE, the information on the second devices in the first band comprises:
receiving, from the UE, a random access request message in the first band;
transmitting, to the UE, a random access response message in the first band; and
receiving, from the UE, Msg3 including the information on the second devices in the first band.

11. The method of claim 7, wherein, based on the first device being included in the third devices, transmitting, to the third devices, the beam sweeping request message including the information on the beam sweeping range comprises:
transmitting the beam sweeping request message including the information on the beam sweeping range to remaining third devices excluding the first device from the third devices; and
performing a beam sweeping in a second band based on the determined beam sweeping range.

12. The method of claim 11, wherein the first band includes B6G (below 6th generation or below 6G) band, and
wherein the second band includes at least one of mmWave band or TeraHertz (THz) band.

13. The method of claim 7, wherein transmitting, to the third devices, the beam sweeping request message including the information on the beam sweeping range comprises:
transmitting, to the third devices, the beam sweeping request message via an Xn interface.

14. A first device operating in a wireless communication system, the first device comprising:
one or more transceivers;
one or more processors controlling the one or more transceivers; and
a memory including one or more instructions performed by the one or more processors,
wherein the one or more instructions comprise:
transmitting, to a user equipment (UE), a reference signal in a first band;
receiving, from the UE, information on second devices in the first band;
acquiring location information of the UE based on a location of the first device and locations of the second devices;
determining third devices and a beam sweeping range of the third devices based on the location information of the UE; and
transmitting, to the third devices, a beam sweeping request message including information on the beam sweeping range.

15. A first node comprising:
one or more memories; and
one or more processors operably connected to the one or more memories,
wherein the one or more processors operate the first node to:
receive first reference signals from a plurality of devices;
perform a measurement on the first reference signals to select a first device among the plurality of devices;
acquire a synchronization signal block (SSB) based on a first reference signal received from the first device among the first reference signals;
acquire information on pre-scheduled resources based on the SSB;
select second devices among the plurality of devices based on the information on the pre-scheduled resources; and
transmit information on the second devices to the first device.

16. (canceled)
